(19) United States
(12) Patent Application Publication
(10) Pub. No.: US 2009/0089113 A1
(43) Pub. Date: Apr. 2, 2009

(54) SYSTEMS, METHODS AND APPARATUSES FOR IMPORTATION AND EXPORTATION PROCUREMENT, LOGISTICS, AND PAYMENT TRANSACTION FACILITATION

(76) Inventors: Armand Rousso, New York, NJ (US); Guy Praisler, Edgewater, NJ (US); Kevin Dorry, Sparta, NJ (US); David Walker, Norwood, NJ (US); Joseph A. Sorisi, Old Brookville, NY (US); Ronald J. Wilkins, Brooklyn, NY (US)

Correspondence Address: CHADBOURNE & PARKE LLP, 30 ROCKEFELLER PLAZA, NEW YORK, NY, 10112, US

(21) Appl. No.: 11/864,898

(22) Filed: Sep. 28, 2007

(51) Int. Cl. G06Q 30/00; G06F 17/00

(52) U.S. Cl. 705/7; 705/26; 705/27

(57) ABSTRACT

The disclosure details the implementation of apparatuses, methods, and systems for market generation and matches of importation and exportation procurement, logistics, and payment transactions; i.e., a cross-border Facilitator (hereinafter “Facilitator”). Through its various components, the cross-border Facilitator creates new markets by generating and facilitating three stages of a cross-border trade transaction: identification, selection and execution. In one embodiment, the Facilitator manages the transaction by: creating a transaction “template” based on transaction information (i.e., HS product code, ISO country code, etc), alerting the buyer to potential problem areas, and updating of important upcoming dates and actions. The Facilitator creates all the required documents, integrates all events, including the service providers, and allows both parties to track the status of the transaction on-line at any time. In one embodiment, the Facilitator receives a search request from a system user, the search request including product and shipping related data. The Facilitator then generates a quote for the transaction and transmitting the quote to the user. The Facilitator receives an indication that the transaction quote has been finalized by the user and effectuates one or more transaction logistics elements based on the product and shipping details included in the finalized quote. The Facilitator then facilitates payment of one or more entities involved in the transaction.

### PRIORITY CLAIMS AND RELATED APPLICATIONS

This disclosure describes inventive aspects of at least five distinct inventions, including:

a transaction creation facilitator (with a suggested U.S. Class/Subclass of 705/20);

a transaction retrieval facilitator (with a suggested U.S. Class/Subclass of 705/24);

a procurement facilitator (with a suggested U.S. Class/Subclass of 705/16);

a logistics facilitator (with a suggested U.S. Class/Subclass of 705/06);

a payment facilitator (with a suggested U.S. Class/Subclass of 705/17);

The instant application details claims directed to procurement facilitation (suggested class/subclass: 705/16), logistics facilitation (suggested class/subclass: 705/06) and payment facilitation (suggested class/subclass: 705/17). However, in order to develop a reader's understanding of the invention(s), the descriptions of the other invention(s) have been compiled into a single disclosure to illustrate and clarify how aspects of these inventions operate independently, interoperate as between individual inventions, and/or cooperate collectively. The disclosure goes on to further describe the interrelations and synergies as between any of the various inventions within the context of an overarching inventive system; all of which is to further ensure compliance with 35 U.S.C. §112.

This disclosure claims priority to under 35 U.S.C. §119 and incorporates by reference U.S. Provisional Patent Applications titled “Apparatuses, Methods and Systems to Effect Cross-Border Payments,” filed Sep. 29, 2006, Ser. No. 60/827,683, Attorney Docket No. 17854-005PV; titled “Apparatuses, Methods and Systems for Market Generation and Matches of Importation and Exportation Transactions,” filed Sep. 29, 2006, Ser. No. 60/827,687, Attorney Docket No. 17854-006PV; titled “Apparatuses, Methods and Systems for a Taxonomy Classifier,” filed Sep. 29, 2006, Ser. No. 60/827,684, Attorney Docket No. 17854-002PV; titled ” Apparatuses, Methods and Systems for Market Generation and Matches of Importation and Exportation Transactions,” filed Dec. 18, 2006, Ser. No. 60/870,561, Attorney Docket No. 17854-006PV1; titled “Apparatuses, Methods and Systems for Cross-Border Logistical Fulfillment,” filed Sep. 29, 2006, Ser. No. 60/827,688, Attorney Docket No. 17854-004PV; titled “Apparatuses, Methods and Systems for Cross-Border Acquisition,” filed Sep. 29, 2006, Ser. No. 60/827,686, Attorney Docket No. 17854-003PV; titled “Apparatuses, Methods and Systems for a Trade Business Card,” filed Apr. 23, 2007, Ser. No. 60/913,521, Attorney Docket No. 17854-010PV.

This disclosure is also related to co-pending Patent Cooperation Treaty patent application no. PCT/______ filed Sep. 28, 2007, entitled ” APPARATUSES, METHODS AND SYSTEMS FOR CROSS BORDER PROCUREMENT,” attorney docket no. 17894-003PC; Patent Cooperation Treaty patent application no. PCT/______ filed Sep. 28, 2007, entitled “SYSTEMS, METHODS AND APPARATUSES FOR IMPORTATION AND EXPORTATION TRANSACTION LOGISTICS FACILITATION,” attorney docket no. 17894-004PC; Patent Cooperation Treaty patent application no. PCT/______ filed Sep. 28, 2007, entitled “SYSTEMS, METHODS AND APPARATUSES FOR A PAYMENT FACILITATION ENGINE,” attorney docket no. 17894-005PC; Patent Cooperation Treaty patent application no. PCT/______ filed Sep. 28, 2007, entitled “SYSTEMS, METHODS AND APPARATUSES FOR IMPORTATION AND EXPORTATION TRANSACTION FACILITATION,” attorney docket no. 17894-006PC; U.S. non-provisional patent application no. ______ filed Sep. 28, 2007, entitled ” APPARATUSES, METHODS AND SYSTEMS FOR A TRANSACTIONAL FACILITATION PORTAL,” attorney docket no. 17894-003US1; U.S. non-provisional patent application no. ______ filed Sep. 28, 2007, entitled “APPARATUSES, METHODS AND SYSTEMS FOR A TRANSACTIONAL PARAMETER SELECTION INTERFACE,” attorney docket no. 17894-003US2; U.S. non-provisional patent application no. ______ filed Sep. 28, 2007, entitled ” APPARATUSES, METHODS AND SYSTEMS FOR A PRODUCT MANIPULATION AND MODIFICATION INTERFACE,” attorney docket no. 17894-003US3; U.S. non-provisional patent application no. ______ filed Sep. 28, 2007, entitled ” APPARATUSES, METHODS AND SYSTEMS FOR A PROJECT AND TRANSACTIONAL PARAMETER BASED SEARCH ENGINE,” attorney docket no. 17894-003US4; U.S. non-provisional patent application no. ______ filed Sep. 28, 2007, entitled ” SYSTEMS, METHODS AND APPARATUSES FOR IMPORTATION AND EXPORTATION TRANSACTION LOGISTICS FACILITATION,” attorney docket no. 17894-004US1; U.S. non-provisional patent application no. ______ filed Sep. 28, 2007, entitled ” SYSTEMS, METHODS AND APPARATUSES FOR A PAYMENT FACILITATION ENGINE,” attorney docket no. 17894-005US1; and U.S. non-provisional patent application no. ______ filed Sep. 28, 2007, entitled ” SYSTEMS, METHODS AND APPARATUSES FOR IMPORTATION AND EXPORTATION TRANSACTION FACILITATION,” attorney docket no. 17894-006US1.

The entire contents of the aforementioned applications are herein expressly incorporated by reference

### FIELD

The present disclosure is directed generally to an apparatuses, methods, and systems of facilitating purchases, and more particularly, to apparatuses, methods and systems for market generation and effectuating importation and exportation procurement, logistics, and payment transactions.

### BACKGROUND

The process of exporting and importing merchandise, or effectuating cross-border trade, is an old process, and in many ways has changed little over the centuries. Many of the traditional entities involved in the trade process are the same: the carrier, the freight agent, the bank, the insurer, the government regulatory agency, the buyer and the seller. Traditionally, the export-import process utilizes hard copy documents for information distribution and storage, multiple third party service providers are managed and coordinated by the trading parties themselves, i.e., management and control of the transaction process and regulatory responsibilities are conducted in-house. Additionally, letters of credit are used as methods of payment and collection. The traditional process is document-based, requiring paper documentation to evidence various elements of the transaction, from quotation to the transfer of ownership and collection of proceeds. This scenario is still prevalent today among most small to mid-sized firms engaged in trade. As such, import/export has long been a physical and interpersonal activity. Buyers, sellers and agents need to negotiate terms, and then have to navigate formidable cross-border regulations and paperwork to engage in the trade of goods. Cross-border trade can also include exporters, forwarders, carriers, brokers, importers, banks, customs, and other players that are involved in facilitating trade.

Over time, various online Business-to-Business (B2B) trade-related web sites have been launched that include trade boards, barter sites, vertical exchanges and portals. Trade boards offer member buyers and sellers trade leads. These trade leads most often contain hyper-links to vendor websites, so that any buyer-seller discovery happens separately between the two trading parties. Examples of these types of B2B sites include TradeXpro.com, and Eceurope.com. Barter sites serve specific sellers who need to sell over-stocked or distress products and often use auction software. Examples of these types of B2B sites include Liquidation.com. Also, sellers may compete for visiting buyers focused on specific products within a given industry. For example, the AgriSeek exchange features agricultural commodities, products and services; Industry2Industry.com links buyers of industrial equipment to its member vendors' websites; the European Plant Exchange serves growers, suppliers and traders of plants and seed in Europe; and Elemica.com, formed by 22 founding chemical companies, facilitates the buying and selling of bulk chemicals on its site. B2B portals offer multi-vertical exchanges. Examples of B2B portals include B2Business.net, Bocat.com, Alibaba.com and Worldbid.com.

### SUMMARY

The disclosure details implementations of apparatuses, methods, and systems for market generation and facilitation of importation and exportation procurement, logistics, and payment transactions; i.e., a Facilitator (hereinafter “Facilitator”). In contrast, current B2B trade portals: 1) do not provide infrastructure to categorize and/or identify goods and/or services for import/export; 2) do not provide an integrated mechanism of acquisition to determine total costs that incorporate regulatory, customs, shipping, handling, timing and/or other logistical requirements for acquisition of goods; 3) do not provide system driven transfer facilitation to determine and provide such logistical requirements (e.g., the generation and execution of the appropriate regulatory, customs, shipping, etc. forms and delivery to the appropriate destinations); and 4) and do not facilitate payments as between the parties. As such, current B2B trade portals are expensive, difficult to use, introduce great inefficiencies, and do not solve the aforementioned problems with existing export-import transactions. In short, existing B2B portals do not offer end-to-end (E2E) electronic cross-border transaction mechanism that facilitates the navigation of intense import-export bureaucracies and processes. The present disclosure overcomes all the aforementioned failings.

Through its various components, the Facilitator creates new markets by generating and facilitating three stages of a cross-border trade transaction: identification, selection and execution. In one embodiment, the Facilitator manages the transaction by: creating a transaction template or transaction record that is based on transaction information (i.e., HS product code, ISO country code, etc), alerting the buyer to potential problem areas, and updating of important upcoming dates and actions. The Facilitator drives generating all the required documents, integrating all transaction events, including the coordinating service providers, and allowing both parties to track the status of the transaction on-line at any time. In one embodiment, the Facilitator provides the user with a seamless solution to ensure all pertinent information is detailed, so that roles and responsibilities of the trading partners are clearly defined and transparent prior to engagement. The Facilitator has many numerous and revolutionary components to facilitate cross-border transactions, such as, but not limited to: a classification taxonomy, multi-lingual facilities, a search-enhancing thesaurus, an acquisition matrix core, a logistical fulfillment matrix, payment matrix, an elegant User Interface (UT), and/or the like.

The Facilitator may facilitate procurement associated with a cross-border transaction. In one embodiment, the Facilitator receives a search request from a system user, the search request including product and shipping related data. The Facilitator then generates a quote for the transaction and transmitting the quote to the user. The Facilitator receives an indication that the transaction quote has been finalized by the user and effectuates one or more transaction logistics elements based on the product and shipping details included in the finalized quote. The Facilitator then facilitates payment of one or more entities involved in the transaction.

### BRIEF DESCRIPTION OF THE DRAWINGS

The accompanying appendices and/or drawings illustrate various non-limiting, representative, inventive aspects in accordance with the present disclosure:

FIGS. 1A-1C provide overviews of various entities that may interact with the Facilitator at various points during system utilization;

FIGS. 2A-2C are high-level flow diagrams illustrating aspects of system-driven transactions;

FIGS. 3A-3D illustrates aspects of a system procurement component according to an implementation of the system;

FIG. 4 illustrates additional aspects of the system procurement component associated an implementation of the system;

FIG. 5A-5E illustrates aspects additional aspects of a system procurement component according to an implementation of the system;

FIGS. 6A-6B illustrates aspects of a system logistics component according to an implementation of the system;

FIGS. 7A-7B illustrates aspects of a system payment facilitation component according to an implementation of the system;

FIG. 8 illustrates aspects of a system data management component according to an implementation of the system;

FIG. 9 illustrates aspects of a Facilitator controller according to an implementation of the system;

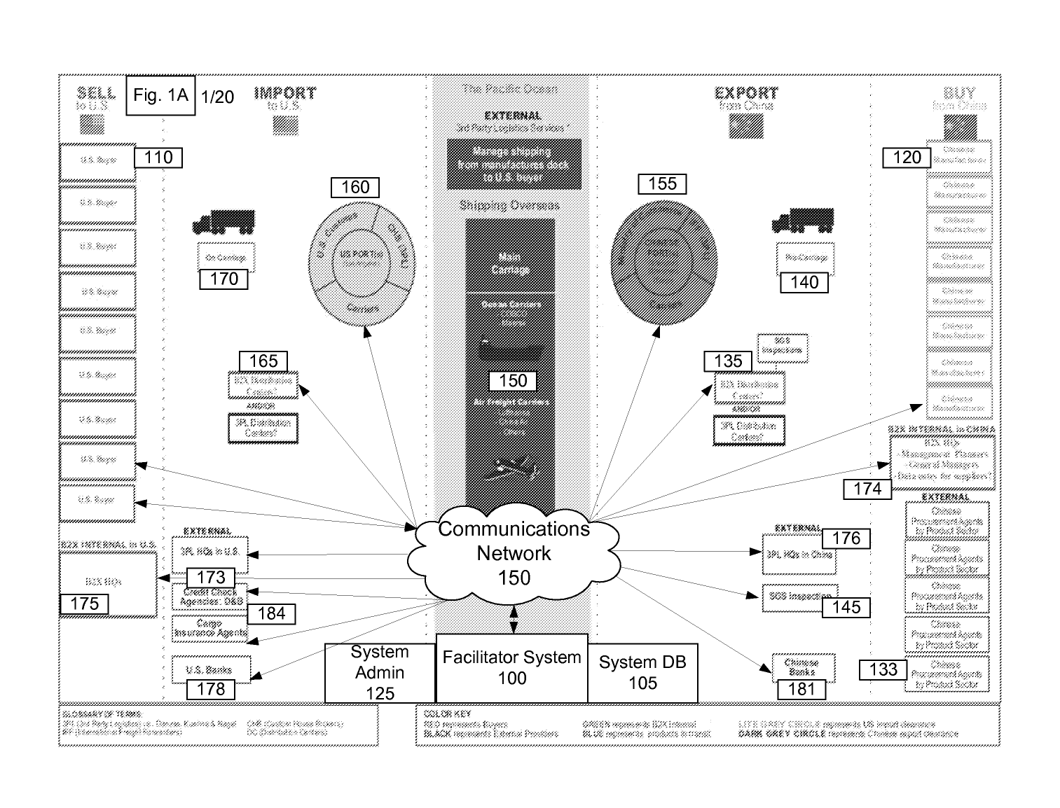

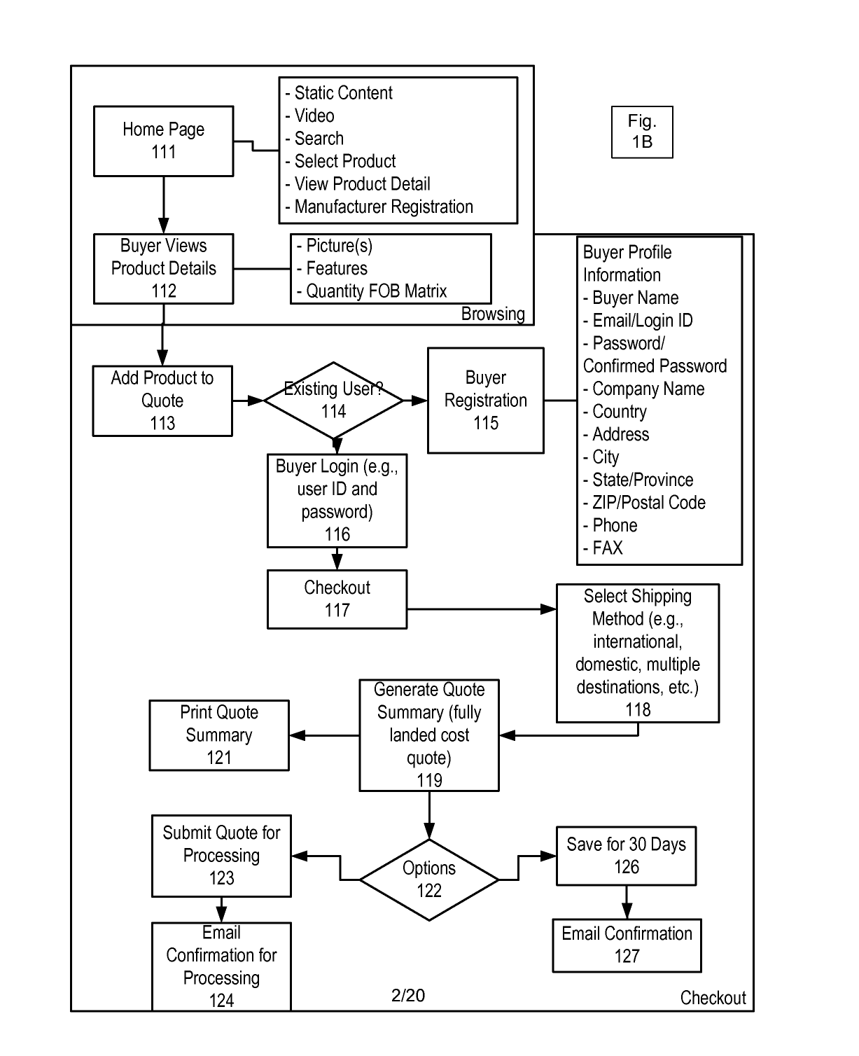

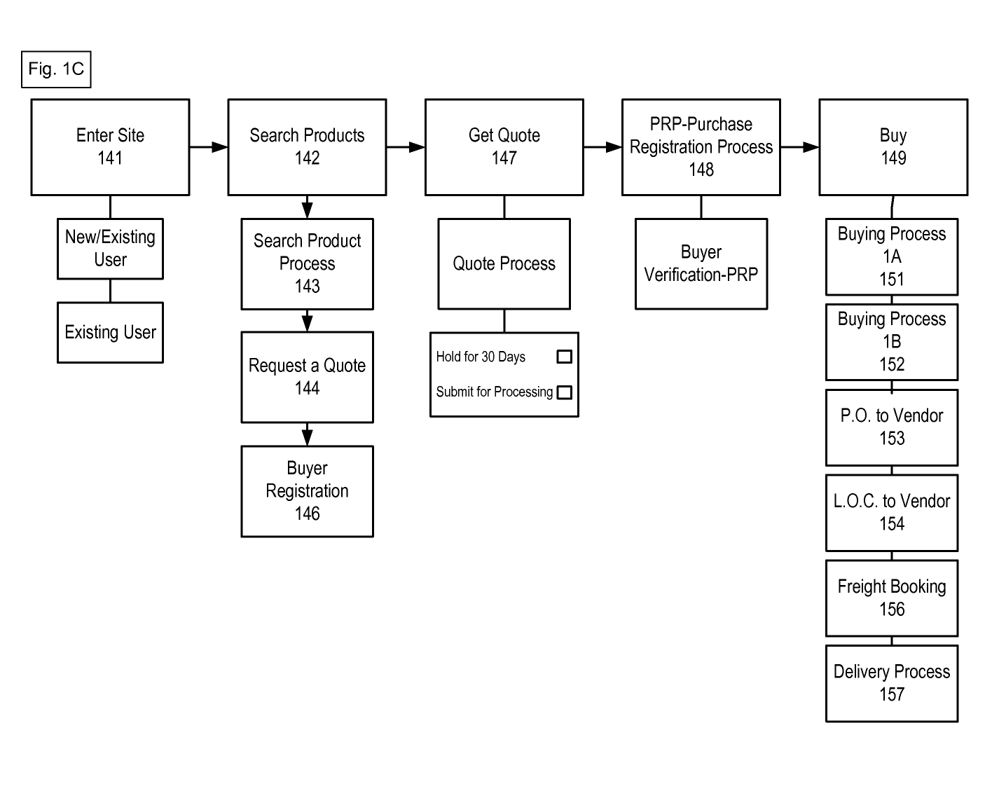

The leading number of each reference numeral indicates the first drawing in which that reference numeral is introduced. For example, communications network 150 is first introduced in FIG. 1.

### DETAILED DESCRIPTION

The disclosure details implementations of apparatuses, methods, and systems for market generation and facilitation of importation and exportation transactions; i.e., a cross-border transaction facilitator (hereinafter “Facilitator”).

Unlike the Facilitator, current B2B portals do not offer an integrated online trade transaction process; i.e., none of the B2B portals offer an end-to-end (E2E) electronic cross-border transaction mechanism that facilitates the navigation of intense import-export bureaucracies and processes. Furthermore, each country's various trade regulations and/or restrictions vary and may impact a transaction depending on the buyer's country with which the trade transaction is taking place. As such, each country-to-country transaction will have a unique set of trade regulations and/or restrictions. This results in an unimaginable number of country-to-country trading pairs of trade regulations and/or restrictions with which trading partners must be familiar in order to complete a transaction. As a result, even if a user finds a trading partner that offers goods in which they are interested, there is no easy way for that user to know what the actual cost of the transaction will be, as the transaction costs of the administrational, customs, duties and/or other related costs of the trade are difficult to discern and surmount. Even if the user can find out what trade restrictions apply to a particular country-to-country transaction, the labyrinth of procuring the right forms for the transaction and properly filing such forms is circuitous at best. As a result, global trading partners will engage in transactions with relatively few trading partners in relatively few regions; it is just too difficult for even sophisticated trading businesses to build a knowledge base in more than a relative few country-to-country pairings of trade processes, regulations and/or restrictions. As difficult as the import-export process is for large and sophisticated trading entities, it is all the more intimidating for small-to-mid-sized-enterprises (SMEs). As a result of such complexity, various consultants and trade intermediaries offer their services to facilitate a variety of segments of global trades, resulting in added costs, intermediary steps, inefficiencies, and/or delays. Furthermore, current B2B portals still require a high level of expert knowledge of the export-import processes, are not consistently and/or systematically integrated with third party service providers and are not integrated between the trading parties. The Facilitator overcomes these failings, by helping a buyer through the transaction process, (e.g., by assisting the buyer address procurement issues, such as finding the right seller for a particular set of goods, logistic issues, such as generating the proper customs paperwork for a transaction between a manufacturer in country X and a buyer in country Y, and address payment issues, such as coordinating payment of each of the various entities involved in a particular transaction

It is to be understood, that the Facilitator may be configured in a variety of implementations in order to meet the particular needs of any number of end users. For the purposes of illustration, aspects of system functionality will be described below in the context of a buyer's search/purchase of a group of widgets. However, it is to be understood that this example is for non-limiting, illustrative purposes only.

FIGS. 1A-1C illustrate aspects of interactions between a variety of entities that may interact with the Facilitator system 100 at different points of a transaction. One or more buyers (e.g., U.S. Buyer 110) logs onto the system 100 in order to search for and purchase some type of goods or services from a manufacturer 120. For the purposes of this discussion, the transaction is effectuated as an international transaction between a US Buyer 110 and a Chinese Manufacturer 120. In order to facilitate these types of transactions, the system 100 includes one or more Facilitator system components, such as a goods/services procurement component, a transaction logistics component, and/or a payment facilitation component.

As illustrated in FIG. 1A, the buyer 110 logs into the system 100 and is able to search for a product, vendor, and/or manufacturer 120. The system database 105 may be populated by a system goods aggregation procurement component. Depending on the implementation, one or more system goods aggregation components may be used to build and populate a catalog with variety of goods, from a variety of vendors and/or manufacturers 120. Once the buyer has identified an item of interest, the buyer may interact with the system 100 (or in some instances a system administrator 125) in order to establish additional transaction characteristics. For example, the buyer may specify a quantity of the goods for shipment, a requested delivery time, and/or a preferred shipping method, which the system may use to develop a transaction cost estimate. Aspects of these interactions are discussed in greater detail below and in related co-pending application titled, “APPARATUSES, METHODS AND SYSTEMS FOR CROSS BORDER PROCUREMENT”, Armand Rousso, filed Sep. 28, 2007, Attorney Docket No. 17854-003PC.

In FIG. 1A, once the transaction procurement characteristics are established, the Facilitator system (“Facilitator”) 100 logistics component and the payment facilitation components coordinate completing the transaction. In an implementation, the system 100 coordinates implementing the logistics associated with transferring the goods from the manufacturer 120 to the buyer 110. The system may be configured to interact with a network of long/short haul carriers 140, 150, in order to transport the goods based on procurement/logistics parameters established in the transaction record. For example, if the buyer does not opt for expedited shipping, the system 100 may coordinate transfer of the goods from the Manufacturer 120 to a distribution center 135 by hiring a trucking or rail service 140, as well as an ocean cargo carrier 150. In another example, the buyer may indicate that the goods are needed as soon as possible and as such, the buyer is willing to pay for an air carrier 150 to deliver the goods expeditiously.

The system 100 is configured to build a transaction record to adhere to local import/export regulations associated with a buyer's and/or a manufacturer's side of a transaction (e.g., export laws for a particular country, cargo carrier regulations, goods' inspection regulations). For example, in some implementations, the system may be configured to retrieve the correct documents for a particular transaction from the local official offices, for example a Ministry of Commerce 155. If local regulations require inspection of the goods prior to exporting, the system may coordinate inspection by an approved inspection firm 145, while the goods are stored at a distribution center 135 or with the Manufacturer 120.

In some implementations, the system may also facilitate one or more intermediate steps associated with transporting the goods from the Manufacturer 120 to the buyer 110, such as transferring the goods from distribution center 135 to a short-haul carrier 140 (e.g, by truck or rail service) for delivery to a long haul carrier (e.g., ocean cargo or air freight carrier) 150.

In addition to facilitating transport, the system may facilitate compliance with import/export regulations, and/or inspection of the goods involved in the transaction. The system 100 accesses the local regulations associated with purchased goods for import into the buyer's country, for example, from US Customs 160 as illustrated in FIG. 1. Various import/export documents and/or forms associated with regulations for a given transaction may be generated for a particular transaction and stored in the system database 105. Accordingly, the system may build a regulatory documentation repository for transactions between any number of countries. In such implementations, the system 100 may also be configured to verify that a stored regulatory document is current and has not been updated by the local regulatory agency before using it as part of a particular transaction. In some instances, it may necessary for the system to work in coordination with third party logistics agents 173-176 in order to comply with various import/export regulations.

Once the buyer's goods have been transported to the buyer's country and have passed through customs, the system may again assist with coordinating intermediary transportation steps for delivery to the buyer 110 (or a system associated/buyer designated distribution center 165 until the buyer is prepared to receive the goods) from a long haul cargo carrier 150, via trucking or rail service 170.

As described in greater detail in co-pending related application, “SYSTEMS, METHODS AND APPARATUSES FOR A PAYMENT FACILITATION ENGINE”, Armand Rousso, filed Sep. 28, 2007, Attorney Docket No. 17854-005PC, the system 100 includes components that may be configured to facilitate and coordinate payment to various entities involved in the transaction. Depending on the parameters of a transaction, the payment facilitation components facilitate significant flexibility and may be configured in a variety of implementations based on the needs/characteristics of a particular buyer/seller. For example, the system may coordinate a transfer of funds between a buyer's bank 178 (or in some implementations a system-affiliated bank) and a manufacturer's (seller's) bank 181 or a procurement agent 133 associated with the seller. In some instances, the payment facilitation components may be configured to facilitate running a credit check on a buyer by working with a credit check agency (e.g., D&B) and/or coordinate insuring the purchased goods during transport, by working with one or more cargo insurance agents 184.

FIG. 1B provides a flow diagram illustrating aspects of the buying process for an embodiment of the Facilitator. A buyer (e.g., U.S. Buyer 110) may navigate to a Facilitator associated homepage 111. At that homepage, the Buyer may have access to Facilitator or seller provided functionality or media, including static content, video, search, product selection, view product details, manufacturer registration, and/or the like. The Buyer may view product details 112 and add the product to the quote 113. The Facilitator may then determine if the Buyer is an existing user 114, and if not, the Buyer may be prompted to register via a buyer registration process 115.

If the Buyer is an existing/registered user 114, they may enter their login (e.g., ID and password) 116, go to checkout 117 and select the preferred shipping method 118. The Facilitator may then generate a quote summary 119, which may be printed 121. The Buyer may then choose one of two options 122, the first option being to submit the quote for processing 123. The Facilitator may then provide the Buyer with an email confirmation of the processing 124. Alternately, the second option involves saving the quote for 30 days 126 (or some other set time period) and receiving an email confirmation to that effect 127.

FIG. 1C provides an overview flow diagram illustrating an aspect of site navigation for an embodiment of a web interface associated with the Facilitator. A new or existing user enters the site 141 (e.g., navigates to the site homepage) and once in the site, the user may search products 142. The user may begin a product search process 143, and once he or she has identified products of interest, may request a quote 144. The user may also register 146. Once the user receives a quote 147, the buyer may submit the quote for processing or have it held for 30 days or some other specified period. The Facilitator may then perform the purchase registration process (PRP) 148, which may include buyer verification-PRP, which in an implementation involves verifying the buyer's registration data, credit and/or other procurement, logistics, or payment facilitaition parameters. Upon successful completion of the PRP 148, the user may buy the indicated items 149. In addition to the buying processes (151,152), a purchase order 153 and letter of credit 154 may be submitted to the vendor, the transaction freight carriers are booked 156, and the delivery process(es) 157 are managed.

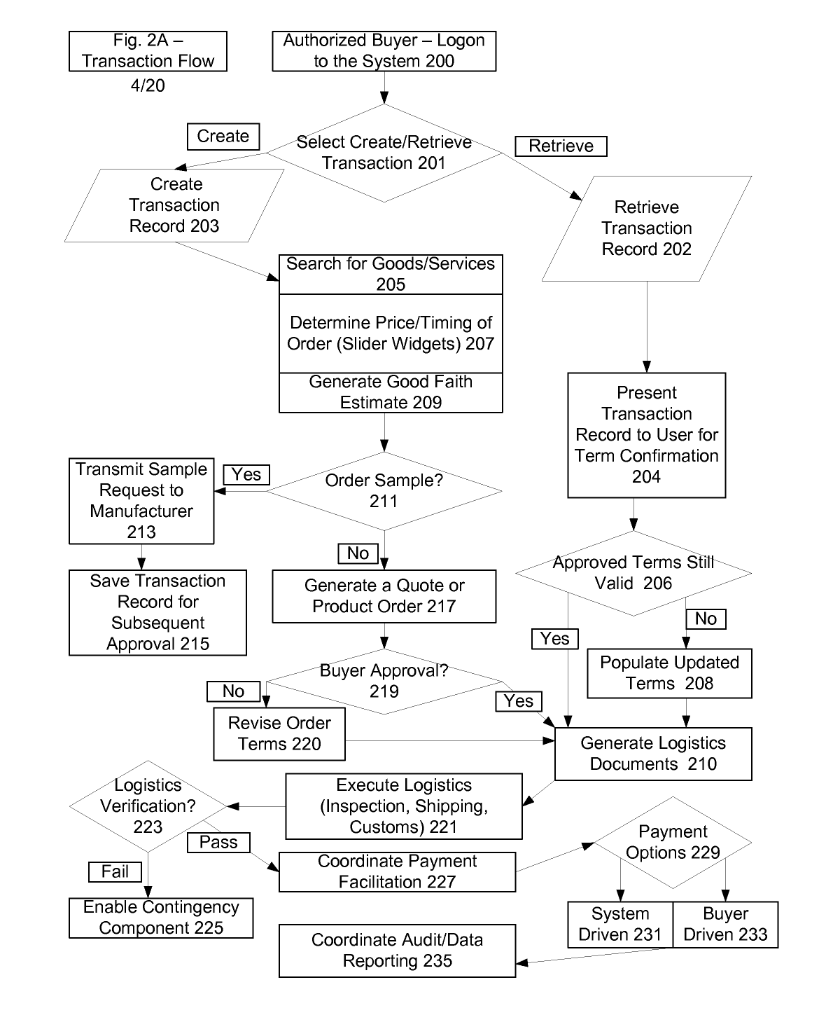

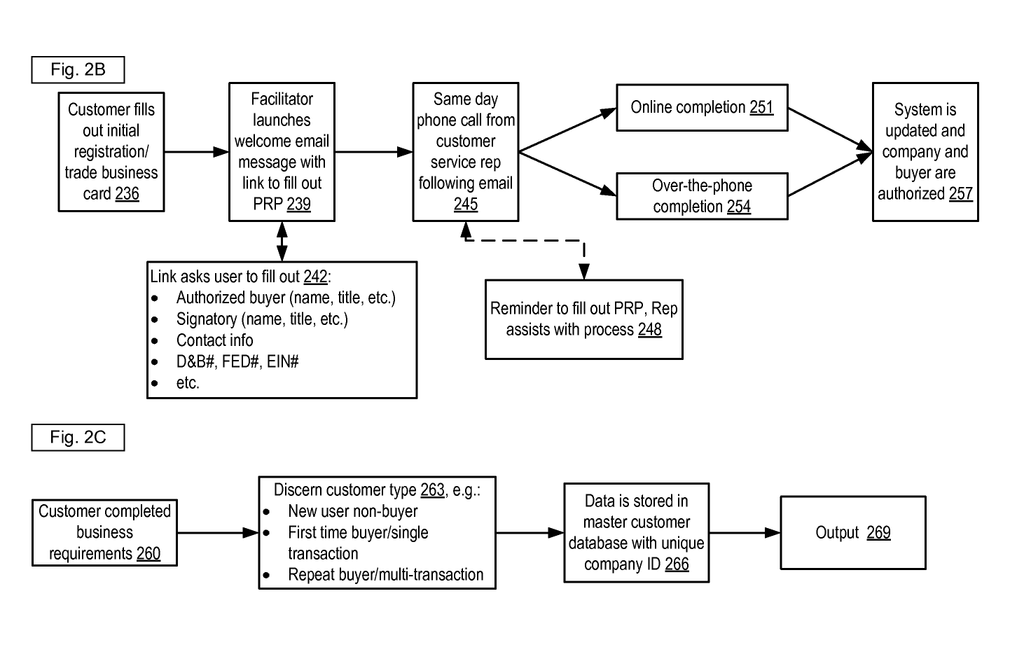

FIG. 2A illustrates an overview flow diagram of aspects of a transaction, according to an implementation of the system 100. An authorized buyer logs into the system to create a new transaction or retrieve an existing transaction record 200. In the example, the system may be configured to generate a transaction record that saves and stores a variety of data parameters that associated with a particular transaction. Elements within the transaction record may be populated and/or retrieved by various system components 201, such as: the system's logistics components, the system's procurement components, and the system's payment facilitation components, or other system components as various parts of a transaction are established and effectuated.

Although FIG. 2A illustrates a registered buyer interacting with the system, the system may be configured to allow access to unauthorized buyers to search for available goods, but in some instances may not allow a buyer to pursue a transaction without becoming an registered (or system-verified) buyer. This is due to the nature of transactions facilitated by the system and a certain level of confidence that a seller may require in a potential buyer before entering into a transaction with the buyer. Accordingly, for illustrative purposes, FIG. 2A discusses transactions within the context of registered buyers. In some implementations, the system may be configured to verify/authenticate certain characteristics associated with buyers during the registration process (and possibly re-confirmed before generating a purchase order), including credit information, incorporation data, corporate tax information and/or any number of types of registration data. Furthermore, the system may use verified/authenticated user data or user preference data to streamline the procurement process, logistics or payments facilitation processes.

Furthermore, in some implementations, the system facilitates transactions for goods that may not necessarily exist at the time the transaction record is created (or accessed). For example, a buyer may be submitting an order for tires to a manufacturer that will be produced and the manufacturer may forward a sample. In some transactions a large number of ordered goods may need to be manufactured in accordance with one or more buyer specifications (alternately, some transactions may also be based on existing goods). As such, a transaction record may have an effective lifespan that may span days, weeks, months or in some instances, even years. Regardless of the exact duration, it is to be understood that the buyer may log onto the system at various points over the lifespan of a transaction record in order to check the status of a transaction record, as well as establish, update and/or effectuate certain aspects or elements of a transaction.

One of the first steps involved in creating and populating a transaction record 203 involves interaction with aspects of a procurement and/or logistics component of the system. For example, after a buyer logs onto the system and indicates that the transaction involves pursuing a new transaction. The system procurement components assist a buyer with searching for a particular type of good or service 205. In some implementations, the procurement component is configured to facilitate a variety of search functionality beyond basic searches for goods or services. For example, a buyer may search for a particular good and/or through a catalog of manufacturers, industries, specialty items or a variety of vertical product groupings within an industry (e.g., consumer electronics within a consumer goods industry). The system may be used to coordinate transactions between two manufacturers for manufacturing machinery, between a manufacturer and a vendor or middle-man, or any other number of buyer-seller configurations.

In the example illustrated in FIG. 2A, once the buyer has identified a particular good 205, the buyer may interact with a procurement interface to establish additional transaction parameters 207 (e.g. quantity, shipping date, etc . . . ). In an implementation, the buyer may interact with one or more system widgets configured to coordinate transaction logistics data with the system's logistics component and a system procurement component. Accordingly, the buyer may submit requests for timing of delivery for the goods (or in some instances set up more than one shipment for a particular transaction), as well as establish other shipping, inspection, and/or customs parameters for the transaction. Once the buyer is satisfied with the various terms associated with the transaction, the buyer may request a system-generated good faith estimate 209 (in some implementations a quote request may be generated by the system at this point). After the good faith estimate is generated, the user may be provided with an opportunity to request a sample of the goods 211. In some implementations, it may be feasible to generate and transmit a sample of a particular good to a potential buyer 213. If a sample of the good is ordered, the transaction may be saved for subsequent update 215, after the sample is received and approved.

However, this may not always be a feasible option based on any number of reasons, such as manufacturing constraints or goods' characteristics. As such, there may be a number of system affiliated quality assurance inspectors or other agencies that certify the quality of manufactured ordered goods. Quality assurance inspections may be effectuated at the manufacturer's location or at various points during the shipping process.

If a sample is requested, the system transmits a sample request to the manufacturer 213 and save the transaction record for subsequent buyer action 215. In various implementations, the system may be configured to save a transaction record for a certain duration, during which the estimated transaction costs are held firm (e.g., 30 days). If the buyer has not accepted the quote (or create a purchase order) by the pendancy expiration date of the quote, the system may delete the expired quote. A buyer who logs onto the system after the expiration of a quote may have to go through the estimate creation process again so that shipping costs, currency exchanges and other transaction expenses can be re-established.

If the buyer is not able to order a sample and wishes to continue with the purchase, the system generates a quote or a purchase order 217. The quote or purchase order is transmitted to the buyer for final approval 219. The buyer is provided with a final opportunity to revise order terms 220, before entering into a binding contract for the purchase of goods or services. Once the order terms for a new transaction are approved, the system may transition to a logistics effication stage 210-227 (described in greater detail below)

Depending on a variety of transaction parameters (e.g., the buyer's system status, the buyer's credit, whether the buyer has repeatedly used the system, the manufacturer involved in the transaction and/or a number of other transaction parameters) the buyer may be provided with an opportunity to lock-in the transaction cost associated with the good faith estimate (or agree to a set cost variation percentage. ±5%). Alternately, the buyer may opt not to lock-in the good faith estimate price and accept the risks that the transaction costs might vary from the good faith estimate. Aspects of establishing the transaction parameters are discussed in greater detail in related applications “APPARATUSES, METHODS AND SYSTEMS FOR CROSS BORDER PROCUREMENT”, Armand Rousso, filed Sep. 28, 2007, Attorney Docket No. 17854-003PC, and “SYSTEMS, METHODS AND APPARATUSES FOR IMPORTATION AND EXPORTATION TRANSACTION LOGISTICS FACILITATION”, Armand Rousso, filed Sep. 28, 2007, Attorney Docket No. 17854-004PC. A buyer logging back onto the system may access an existing transaction record 202.

In accessing a previous transaction, a buyermay log back onto the system after the initial transaction parameters have been established. As in FIG. 2A, the system procurement component retrieves the transaction record 202 (if the transaction has not expired and the transaction record deleted). The transaction record parameters are presented to the buyer for re-confirmation 204, where the buyer confirms the transaction parameters. The system also re-verifies that the approved terms are still valid 206. The system may facilitate updating the transaction parameters 208 if the buyer wants to change aspects of the transaction or if the system determines that one or more parameters are no longer viable (e.g., one of the shipping quotes may have expired). If the terms have expired or if the buyer wants to update (or modify) the transaction parameters, the system may be configured to update the transaction terms 208. After the transaction parameters have been finalized, the system's logistics components generate the logistics documents 210 and effectuates the various logistics elements of the transaction 221.

If the buyer approves the purchase order or if the approved transaction parameters from a retrieved transaction record are valid 206, a binding contract is created and the system transitions to the transaction record to a Logistics effectuation mode 221. The system may be configured to verify that the initial logistics schedule is still viable 223. In an implementation, the system may be configured to generate a logistics milestone schedule. The milestone schedule may be incorporated as part of a transaction record and acts as a checklist of important checkpoints during transaction effication, such as when the manufacturer creates and ships the goods to the buyer or the goods pass through US customs (aspects of the milestone schedule are discussed in greater detail in “SYSTEMS, METHODS AND APPARATUSES FOR IMPORTATION AND EXPORTATION TRANSACTION LOGISTICS FACILITATION”, Armand Rousso, filed Sep. 28, 2007, Attorney Docket No. 17854-004PC). Aspects of the logistics verification process 223 involve confirming that various shipping, inspection, goods storage and/or a number of other services that comprise the logistics effication process are still available and in some instances are still available at the initial quoted prices. If the system logistics verification fails, the system accesses system contingency components 225 that facilitate identifying, presenting to a buyer, and in some implementations reserving alternate shipping, inspection and/or storage facilitates or other aspects of the logistics effication.

If the system is able to verify the logistics data, the system payment facilitation components are accessed 227. The system's flexibility is also demonstrated by the various implementations of system payment facilitation components. For example, the system presents available payment options to a buyer 229. Depending on the implementation, the listing of available options may be customized based on processing the buyer's data, for example a buyer's verified credit rating. Alternately, the system may establish a buyer confidence based payment metric based on a buyer's historic system use

In some implementations, the system may be configured to provide a system-driven payment facilitation model 231. For example, in a system driven payment facilitation model, the buyer submits a letter of credit from a buyer's bank. After verifying the letter of credit, the system may receive payment from the buyer's bank. In turn, the system facilitates payment of the manufacturer, the various shipping carrier(s), any duties/tariffs, inspectors, and/or any other entities associated with a transaction.

In contrast, the system may facilitate a buyer driven payment facilitation model 233. In an example of the payment facilitation model, system resources may still be utilized to establish various aspects of the transaction, but with regard to payment, the system is only involved to the extent that system generates a payment statement for system services rendered. In other words, the system may receive a payment indication limited to the amount charges for system services—individual disbursements to the various entities involved in the transaction are coordinated by the buyer. After the transaction is completed (generally after the last disbursement is effectuated), the system may be configured to conduct a transaction data audit or data reporting 235.

As the Facilitator may be configured to mediate transactions that ranging from small-scale transactions to large-scale, international, and/or otherwise complex transactions, the system may be equipped to implement a purchase registration process comprising a buyer verification procedure. FIG. 2B illustrates an implementation of logic flow for buyer registration/verification in one embodiment of Facilitator operation. A buyer fills out an initial set of information, such as registration information, a trade business card, and/or the like 236. After receipt of initial buyer information, the Facilitator may supply a welcome email message requesting the buyer to fill out additional information for the purchase registration process 239, such as via an internet link 242. The additional information may, for example, comprise authorized buyer information (e.g., name, title, and/or the like), signatory information (e.g., name, title, and/or the like), contact information, Dun & Bradstreet number, tax status identification, employee identification, and/or the like.

To assist the customer with providing the purchase registration process information, a same-day phone call from a Facilitator representative/system administrator may be made 245, including a reminder and assistance with filling out the required information 248. In various implementations, the customer may be required to fill out the information online 251 or over the phone 254 or may be provided an alternate option. Upon successful completion of the process, the system is updated and the company and associated buyer are authorized to make the purchase and/or subsequent purchases 257. In alternate implementations, steps in this process may occur before or after the customer selects one or more products for purchase, or the entire process may occur at the time of initial customer registration before subsequent product purchases are allowed.

Customer entered information may, in one embodiment, be analyzed and/or incorporated into marketing database for use in future marketing and targeted sales. FIG. 2C shows an implementation of logic flow for a lead generation process in one embodiment of Facilitator operation. At 260, a buyer or system customer completes a set of business requirements, such as interacting with the Facilitator to enter information into a user profile, generate a trade business card, engage in one or more transactions, generate a quote, and/or the like. The customer information is analyzed at 263, and the customer may be assigned one or more keywords, tags, categorizations, and/or the like based on an analysis of the entered information. For example, based on the date of customer registration and a count of the number of purchases made by the customer, he or she may be classified as a new user non-buyer, a first time buyer with a single transaction, a repeat buyer with multiple transactions, and/or the like. The customer data, including customer type, may then be stored in a master customer database in conjunction with a unique customer and/or company ID 266. This master customer database may then be accessed for a variety of marketing needs and/or may yield a wide variety of outputs 269, such as but not limited to: comprehensive customer lists; customer lists filtered by category, customer type, industry, products purchased, products viewed, and/or the like; and/or the like.

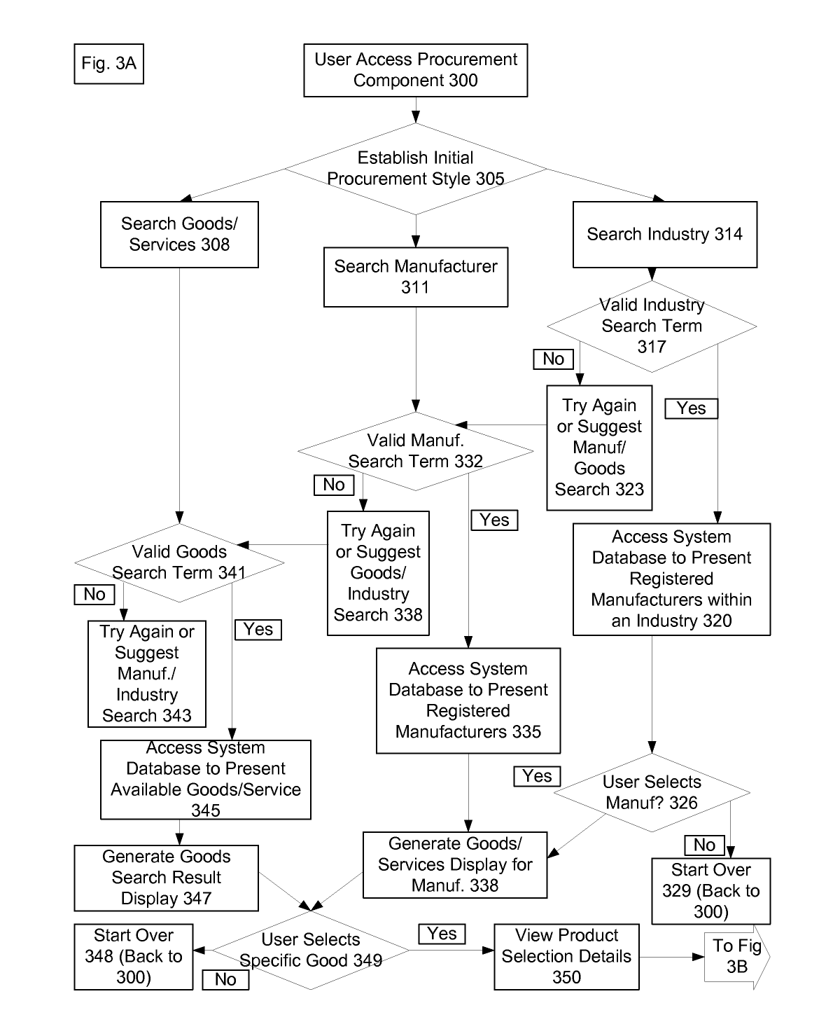

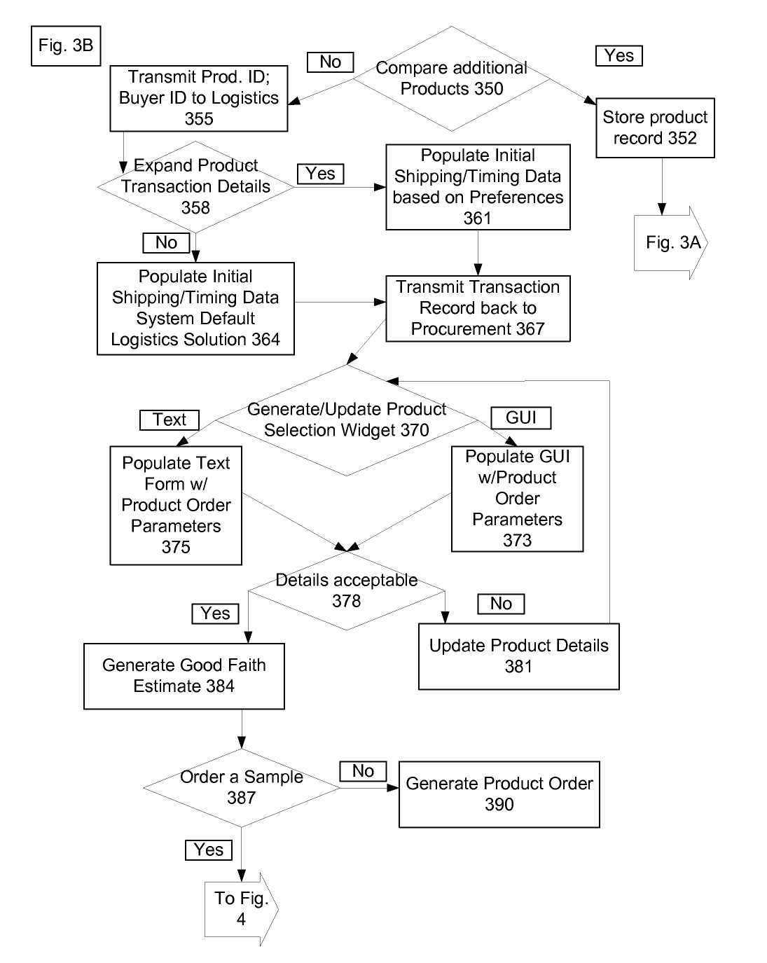

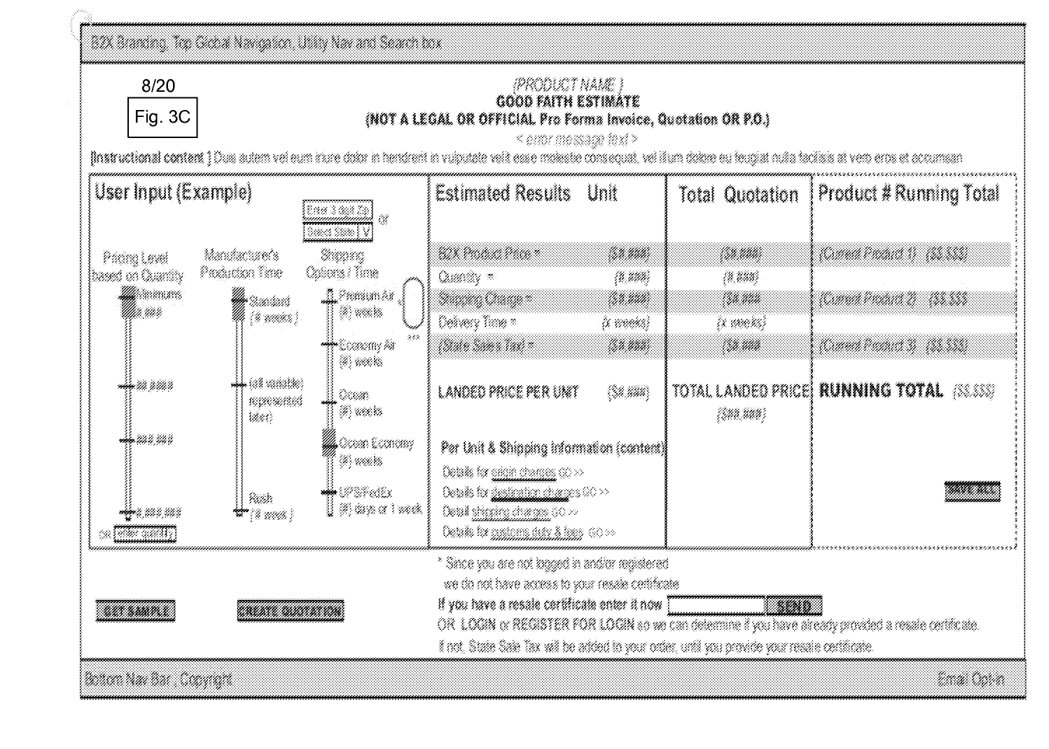

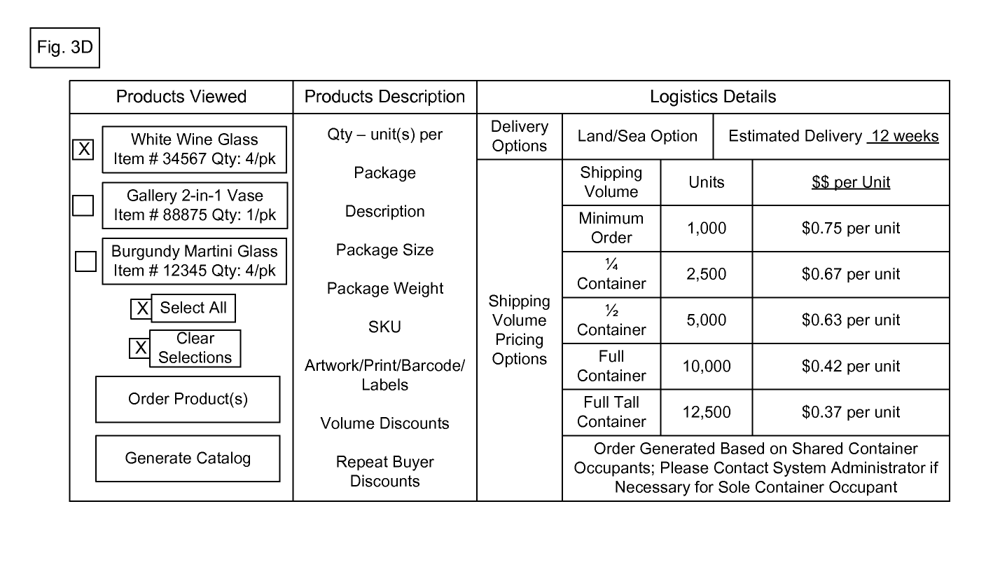

FIG. 3A illustrates aspects of a buyer procurement component 300, according to an implementation of the system. In the implementation illustrated in FIG. 3A, the user is presented with a variety of procurement search options and can select establishing and initial procurement search system 305. A buyer may drive a procurement search for goods/services 308, search based on a manufacturer 311, and/or for items within a particular industry 314. In certain implementations, logistics parameters may be used to assist a user in conducting the search (e.g., the buyer may search for 10,000 wine glasses deliverable within a eight week time window. This facilitates significant flexibility for a user and provides a varying scope for user search. For example, the user may be provided with a listing of available industry search terms to select from.

Alternately, the user may input a search term that corresponds with a particular industry 317 (e.g., apparel, appliances, electronics, etc . . . ). If the industry search term is a viable search term, the user may be provided with access to a system database with a listing of manufacturers and/or manufacturer products within the particular industry 320. If the user selects a manufacturer 326, the product catalog for the manufacturer may be displayed associated with the manufacturer may be displayed 338. The user may be provided with an option to restart the search 329 and transition back to the initial procurement search style selection 305.

If the user inputs an invalid industry search term, the system may be configured to suggest that the user try again and/or suggest one or more registered alternative industry search term 323. In another implementation, the system may be configured to suggest that the user try a Manufacturer search 311 or a products search 308. The system may also be configured to suggest one or more search terms based on the underlying industry search term. If the user inputs a valid manufacturer search term 332 the system may provide access to a listing of one or more registered manufacturers 335. If the user selects a particular manufacturer from the listing, the system may generate an offered goods/services display listing associated with to a particular manufacturer 338. The user may select a specific good 349 in order to view product specification/pricing details 350.

The buyer may select a specific goods/services 308 search. The system determines if the buyer entered a valid goods search term 341. If the system determines that the search term is invalid, the system may generate a suggested manufacturer/industry search term based on the invalid goods search term. Alternately, the system may be configured to request the buyer enter a new search term 343. If the buyer has entered a valid product search term, the system may provide access to the system product database 345 by generating and displaying a goods search result 347. For example, the system may display a search result listing that includes exact product search result matches and in some implementations system generated related product search results. The buyer may select a particular good 349 for inclusion as part of a purchase shopping cart, potential product catalog offering and/or simply to view product specification/pricing details 350. As part of the product display component, the buyer is presented with the option of conducting additional searches or starting the search over 348.

FIG. 3B illustrates aspects of an implementation of system procurement/logistics components. After viewing a product's specification/pricing details, a buyer may be presented with the opportunity to compare additional products 350. The system may be configured to save the product record as part of a buyer's shopping cart or potential product catalog (PPC) 352 and then search for additional goods/service by transitioning back to the initial procurement access point 300 in FIG. 3A. Alternately, the buyer may not want to compare products and instead want to view detailed transaction logistics options associated with a particular product 358 as a potential transaction.

In a system implementation, the product characteristics display module coordinates with the logistics components to determine and display product specifications, as well as product pricing and shipping details. In another system implementation, the procurement component transfers a product identifier (e.g., a manufacturer's product SKU value) to system logistics components to generate product pricing and shipping details according to a registered buyer's preferences 355. The system may be configured to display these details based on a registered user's established preferences 361 or as a system default logistics solution 364.

By way of example only, a registered buyer may establish a preference that defaults product data display parameters to display shipping charges based on a least expensive shipping solution, a fastest shipping solution, a balanced shipping solution or a number of other registered buyer preference options 361. Alternately, for a non-registered buyer, the system may default to displaying a least expensive shipping 364 (or other type of default solution) and present additional shipping options as alternatives for the buyer to select (as shown as display widget 3C).

It is to be noted that as illustrated in the widget FIG. 3C, the logistics parameters may have a certain amount of interdependence. For example, requesting a fastest shipping solution, may corresponding to eliminate several options that are slower, but may be more cost effective. As such it may be possible to use logistics windows in generating the requested logistics solution. For example, instead of the fastest shipping solution, a buyer may request to see the top 3 expedited shipping solutions in order to determine if any expedited shipping solution may also be cost effective.

The pricing data associated with the various shipping solutions are determined by the system logistics components, which may be populated based on current shipping rates/schedules, real-time quote requests and/or previous system transaction data associated with a number of carriers. After the transaction record is populated with the pricing data, the transaction record may be transferred by the procurement modules for display to the buyer 367.

Depending on the particular implementation, the procurement system module may be configured to display product transaction data in a number of ways based on the needs of a particular buyer or seller or the characteristics associated with a good/service 370. As such, the system may generate an interactive Graphical User Interface pricing widget 373 that displays shipping costs based on the buyer interacting with the widget to set values for the various pricing factors 364 (e.g. volume discounts, alternate shipping options). Alternately, the system may generate a product pricing matrix 375 that displays various text options available for a particular good or service.

For example, often a buyer working with a manufacturer may be interested in a significant volume of a particular good. Depending on the size and make-up of the particular good the buyer is interested in, the shipping costs may vary across a broad range. Ultimately, this information, in coordination with the packaging data may be used to derive one or more shipping pricing points based on several standardized or customized quantities of goods.

If the buyer requests a pricing widget 373 (illustrated in FIG. 3C), the system generates the widget and populates the widget with initial data established by a system default or a registered buyer's preference data. If the buyer requests a text display interface 375, the system generates and displays a product specification along with a pricing matrix (illustrated in FIG. 3D). Based on the displayed product specification/pricing details, the buyer may then indicate whether the terms are acceptable 378. If the buyer is not satisfied with the current transaction parameters, the may may further update product details 381.

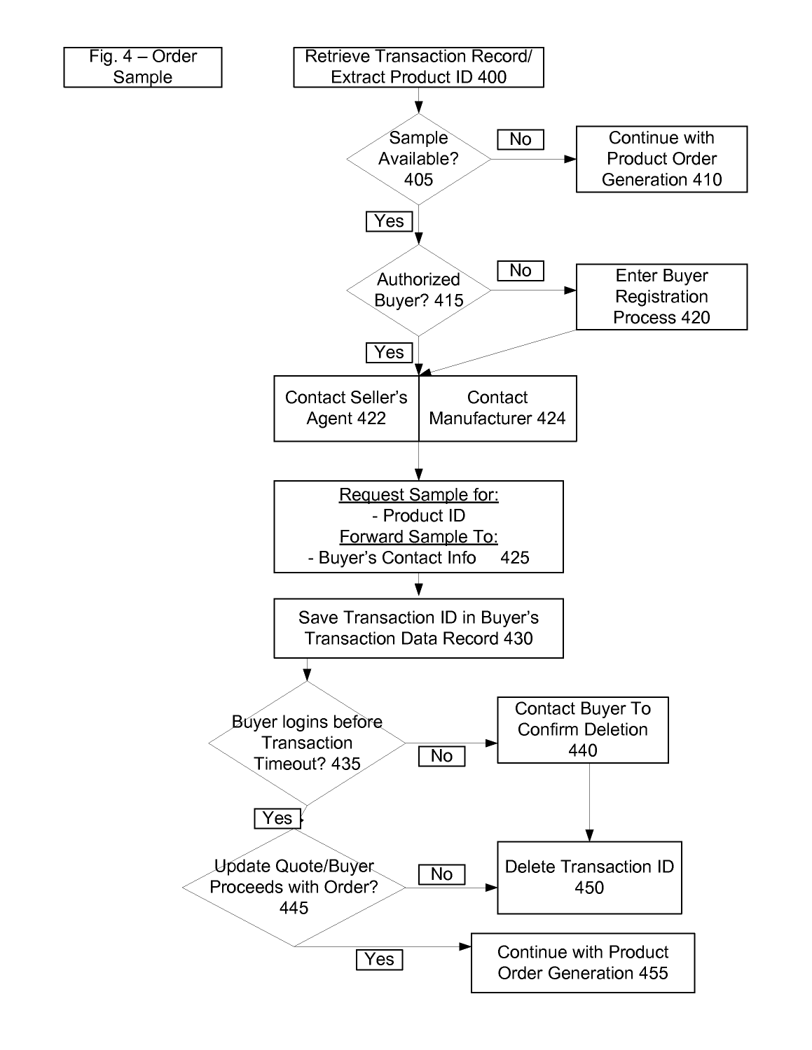

In some implementations, the system is configured with a buyer's chat module, in which a buyer may attempt to negotiate additional buyer's discounts based on repeat business purchases, volume discounts or a number of other factors. If the product pricing terms are acceptable, the system may generate a good faith estimate and/or a product quote request 384. In some implementations, the buyer may be provided with the option to order a sample of the good (discussed in greater detail in FIG. 4 below).

If the buyer is satisfied with the transaction details, the buyer may opt to generate a product order 390. Depending on the actual implementation, the buyer may print out, sign and date a product quote request. The signed/dated product quote request may then be transmitted back to the system via email (or in some instances fax the executed quote request to a system administrator). The system/system administrator may verify the buyer quote date, confirms the logistics information with the manufacturer, shipping carriers, inspectors, or other entities involved in the transaction and then can generate a purchase order—as a binding contract. However, before returning an executed the quote request, the buyer may be provided with an opportunity to pursue obtaining a sample 387.

FIG. 4 illustrates a system component configured to facilitate product sample ordering (387 from FIG. 3B). The system accesses the transaction record and extracts the product specification parameters established by a manufacturer during a product registration process 400. One of the product specification parameters may be a ‘sample available’ indicator 405. If the sample is unavailable for the selected product(s), the system may suggest that the buyer work with a system affiliate or 3rd party product inspector. Alternately, the buyer may rely on certain system product certifications which may be provided in certain instances. Alternately, the system may proceed with purchase order generation 410. If the product sample is available, the system may verify whether the buyer is a registered buyer 415. If the system determines that buyer is not a registered buyer, the system may transition to a buyer registration process 420 before proceeding ordering a sample. If the buyer is a registered buyer, the system may proceed with ordering a sample by contacting either a seller's/vendor's agent 422 or the manufacturer 424 directly. The sample request may include a product ID, product specifications (and in some instances a buyer's requested modifications to the product specifications), as well as the buyer's shipping address 425.

The system also manage active pending orders and cull orders that have become stagnant. For example, most transactions have a transaction lifecycle. Accordingly, the system may include a stagnation date for each transaction as part of the transaction record. The stagnation date is a maximum transaction inactivity period (e.g., 30 days) after which the transaction record is transitioned to an inactive transaction queue for the buyer. In the inactive transition queue, the various product/shipping transaction parameters are saved, but the pricing points may have to be re-established. The transaction record may be saved on the inactive transaction queue without further update from the buyer for a predetermined period of time (e.g., 15 days) before the transaction record is deleted from the system. The transaction inactivity period may be extended under certain circumstances. For example, the transaction inactivity period may be extended when a registered buyer orders a product sample and the transaction inactivity period may be extended by the number of days associated with shipping a sample to the buyer. In some instances, the transaction inactivity period may be further extended by a product sample evaluation period (e.g., 3 days). In the implementation of the system illustrated in FIG. 4, the system may extend the transaction inactivity period and store the adjusted period as part of the transaction record 430.

In contrast, if the ‘sample available’ parameter indicates that a sample is not available for the particular product. The system may present a manufacturer's specification warranty or a system certification for a particular manufacturer 410. In some implementations, the system may be configured to maintain a manufacturer rating system that allows buyers to provide feedback describing their experience with a particular manufacturer for a given transaction 410. As part of the offered services facilitated by the system, the system may provide a listing of system-affiliated or independent third party product inspectors 412. These inspectors may provide a variety of quality assurance services, including inspecting the specific products and/or the production facilities. The system may be configured to adjust the transaction inactivity period if a product/facility inspection is coordinated.

The buyer may access the transaction record after receiving the product sample or the quality assurance report 435 before the expiration of the transaction inactivity period. As the expiration date approaches 440, the system may generate and send an email to the buyer advising that the transaction period is about to expire and that the transaction may be shifted to the inactive transaction queue or in some implementations deleted 450. The buyer may access the transaction record and request addition time to evaluate whether to proceed with the transaction. Alternately, the buyer may initiate a final quote request, approving the initial terms associated with the transaction 445. Receiving a final quote request, the system initiates the quote verification discussed in FIG. 3B and generates a purchase order if the quote is verified 455.

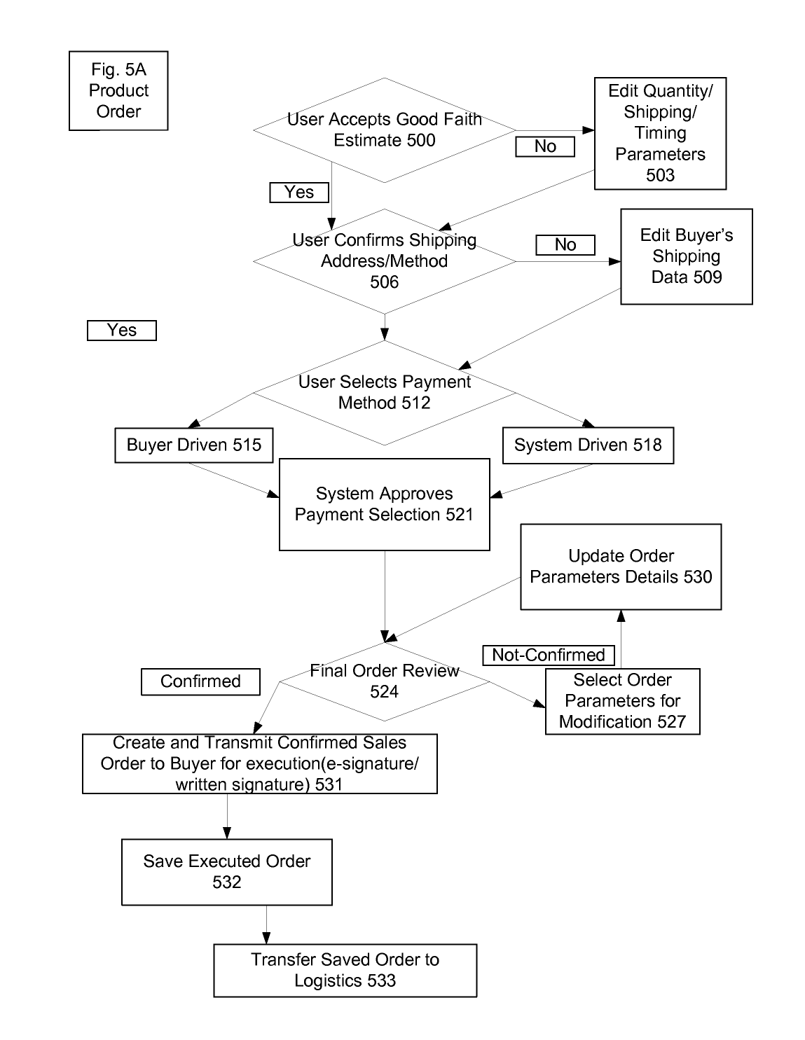

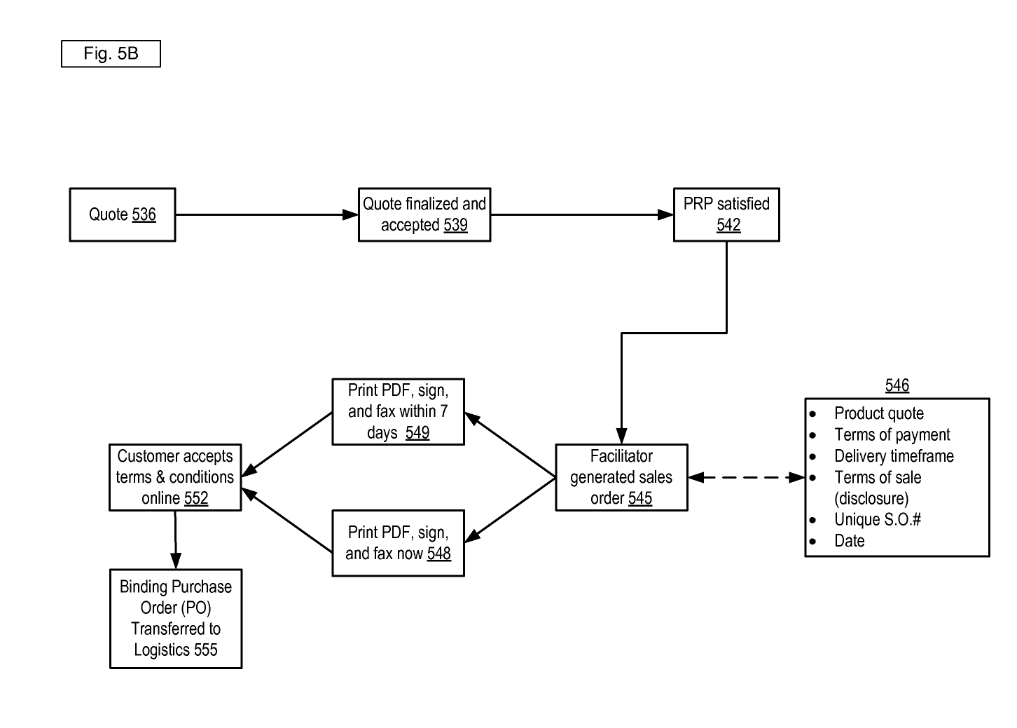

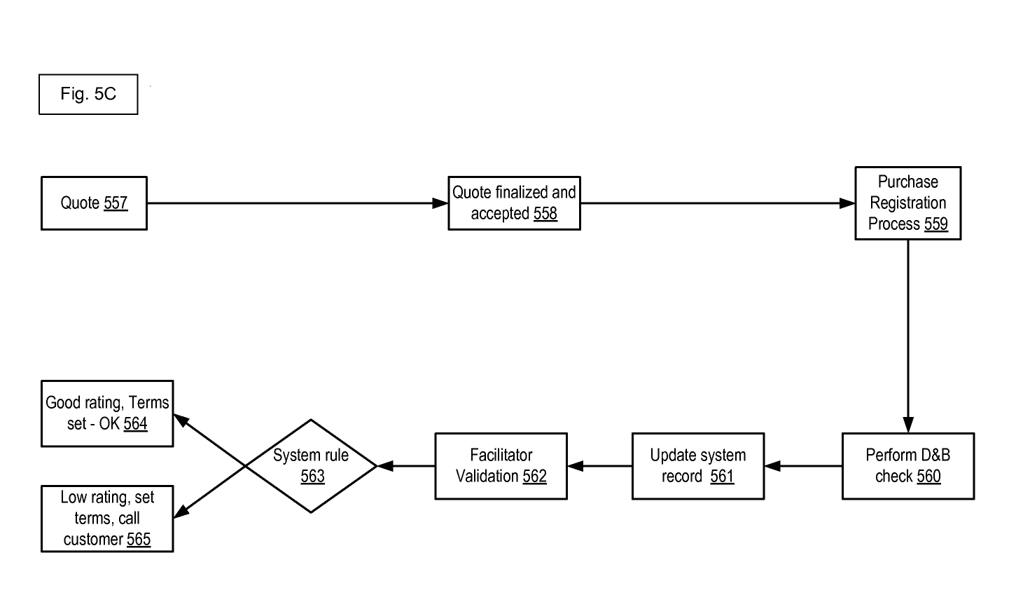

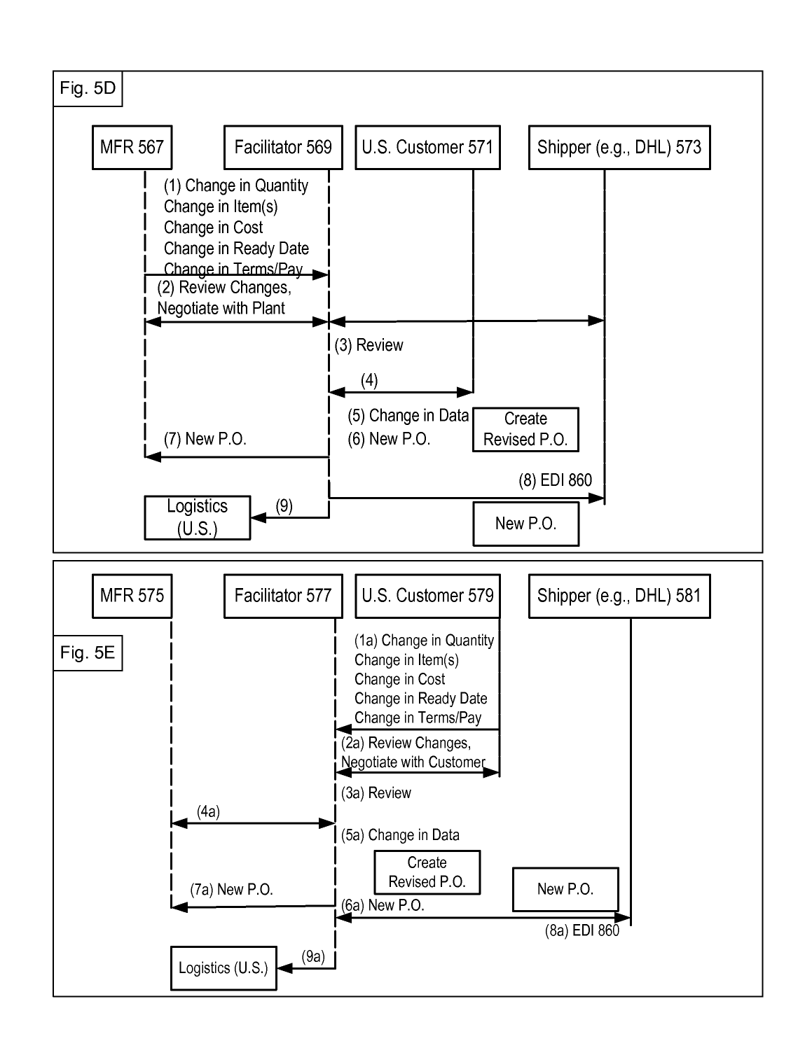

FIG. 5A illustrates aspects of the process associated with transitioning between the system generating a good faith estimate or a finalizing a quote request (in some instances generating a binding purchase order) 500. The transition between generating a good faith estimate/quote request is one of the last points in the transaction that the buyer may edit transaction parameters 503 before a binding contract is established as a purchase order. If the buyer is satisfied with the transaction parameters, the buyer confirms the shipping address(es) and shipping method(s) is correct 506 (and may update the data, if necessary in 509). The buyer then selects the payment method 512 as buyer-driven 515 or system-driven 518. If the buyer selects a system driven payment method, the system may confirm that the buyer has the resources (e.g., by conducting a credit check) to cover the costs associated with transactions 521. As will be described in greater detail below, in a buyer-driven model, in certain instances, the system may verify that payment has been effectuated and if it has not, effectuate payment on behalf of the buyer. The system may be configured to determine whether a buyer selecting a buyer driven model has also requested ‘system assurance’. The system may also verify 521 that a buyer requesting system assurance has the resources to cover the expenses incurred by the system, if the system has to effectuate payment on behalf of the buyer due to a buyer's delinquent payment.

After the payment method is established, the buyer is provided an opportunity to give the quote a final review 524. If the buyer does not confirm the final quote, the system may present the buyer with the opportunity to select various parameters for modification 527, as well as update the selected parameters 530 and reconfirm the final quote. Once the quote request has been finalized and confirmed by the buyer 524, the system generates and transmits a copy of the finalized quote request to the buyer 531. The buyer, in turn, executes the finalized quote request and transmits the executed request back to the system. The system receives an indication that the executed request has been received, saves a copy of the executed/authorized order 532 and transmits the transaction record associated with the authorized order to the system logistics components to initiate logistics effication processes 533.

FIG. 5B shows an implementation of quote/binding purchase order generation for another embodiment of Facilitator operation, in which a purchase registration process has been successfully completed. A quote is generated and provided for review to a customer at 536, who again has the option to finalize and accept it 539. If accepted, satisfaction of a purchase registration process may be checked and/or verified 542, and the Facilitator may generate a sales order 545 corresponding to the one or more selected products and/or generated quotes. An example of some elements of such a sales order are provided at 546, and include a product quote, terms of payment, delivery timeframe, terms of sale, a unique sales order number, the date, and/or the like. The sales order may further include one or more disclaimers (e.g., specifying the validity period for the terms) and/or instructions for the buyer to realize and/or finalize the purchase.

In one implementation, a PDF and/or other electronic copy of the sales order may be generated and supplied to the buyer, or a hard copy may be generated from the electronic copy and provided to the buyer. The printed copy of the sales order may, in one implementation, be printed, signed, and faxed to the Facilitator and/or a Facilitator administrator immediately by the buyer 548 or, in an alternate implementation, the buyer may be allowed a specified period of time (e.g., 7 days) in which to return the signed sales order 549. In addition to faxing, the sales order may be returned by a wide variety of other means in various alternative implementations, including postal mail, scanning and returning an electronic copy, and/or the like. Finally, when the signed sales order is received, the Facilitator may provide the customer with a set of terms and conditions for review 552, which the customer may then decide to accept in order to finalize the purchase. At this time the system saves a record of the binding purchase order and transfers a copy of the transaction record (which may include the binding purchase order) to system logistics components associated with the system.

After an initial quote has been generated but before the purchase is finalized, a verification analysis may be performed in order to finalize the quote. FIG. 5C shows an implementation of logic flow for a buying process in one embodiment of Facilitator operation. First, a quote is generated 557 in response to a selection of products by the customer and a request for quote generation. A quote that is provided online, such as on the web or in an email message, may be provided with a yes/no acceptance button. The customer may also be provided with options to re-check all quantities, costs, and/or the like; to accept the quote as is; to edit quantities, add, or delete items; and/or the like. In one implementation, a quote that is less than a particular number of days (e.g., 30) old may be final, while a quote that is older than that period may be automatically updated when the customer accepts it and a notification of the update and/or of the expiration of the previous quote may be provided to the customer.

For a valid quote, the customer is provided with the opportunity to finalize and accept the quote 558, and an accepted quote may trigger the purchase registration process 559 and/or query information supplied by a previously completed purchase registration and/or buyer verification process. Buyer identification and/or verification information may be extracted from the purchase registration process information and used to perform a check of the buyer's reliability, credit worthiness, purchase history, business background, and/or the like. For example, in one implementation, the Facilitator may perform a Dun & Bradstreet check on the buyer based on buyer identification information 560. Subsequent to the check, system records are updated to reflect the buyer's status and/or their current interaction with the system 561, and a Facilitator validation process may be undertaken 562 to assess the outcome of the buyer check and/or to apply a system rule 563 (e.g. a rule that would determine whether a buyer has credit, the buyer's credit is below a certain threshold credit score, or would otherwise identify the buyer as a potential credit-risk the system may require collateral).

As another example, a buyer credit score may be analyzed to determine whether it is sufficiently high to warrant a particular sale based on credit. For a good rating with respect to the system rule, the terms are set based on the quote and the transaction is allowed to proceed 564. Otherwise, for a low rating, an alternative set of terms may be generated to take into account the buyer's status and/or a message may be conveyed to the buyer to indicate the circumstances and determine an appropriate course of action thereafter 565.

FIG. 5D illustrates the process of changing aspects of a finalized purchase order. By way of example only, FIG. 5D illustrates a data flow associated with a manufacturer modifying elements within a finalized purchase order according to one embodiment of the Facilitator. The manufacturer 567 communicates a need to make changes (e.g., a change in quantity, item(s), cost, ready date, terms/payment, and/or the like) to the Facilitator 569. The Facilitator 569 may review the requested changes and negotiate with the manufacturer 567. The Facilitator 569 may then transmit the information to the customer 571 for approval/rejection. If the customer 571 approves the proposed modifications, the associated transaction data may be changed/updated, a new purchase order created, executed by the customer 571 and sent to the Facilitator 569 for forwarding to the manufacturer 567. If the changes affect shipping (e.g., delivery date, increased shipping quantity, different product size/weights, etc . . . ), the Facilitator may forward the new purchase order to shipper 573 to determine whether the shipping logistics parameters need to be updated (e.g.,original price quotes, shipping pick-up dates, or other shipping parameters need to be updated. After the logistics update is completed if necessary, a finalized copy of a new purchase order is also provided to the shipping entity 573. The Facilitator may then update the corresponding logistics component modules (e.g., a logistics milestone watchdog component).

FIG. 5E provides an example data flow for a customer 579 changing a purchase order in one embodiment of the Facilitator 577. The customer 579 communicates a need to make changes (e.g., a change in quantity, item(s), cost, ready date, terms/payment, and/or the like) to the Facilitator 577. The Facilitator 577 may review the requested changes and negotiate with the customer 579 and in some instances include the Manufacturer 575 in the negotiations. The Facilitator 577 may then review the proposed purchase order modifications and communicate the proposed changes to the manufacturer 575. If the manufacturer 575 approves, the associated transaction data may be changed/update, and a new purchase order created and sent to the manufacturer 575 and the shipper 581. The Facilitator then updates the system logistics components (e.g., logistics milestone watchdog component).

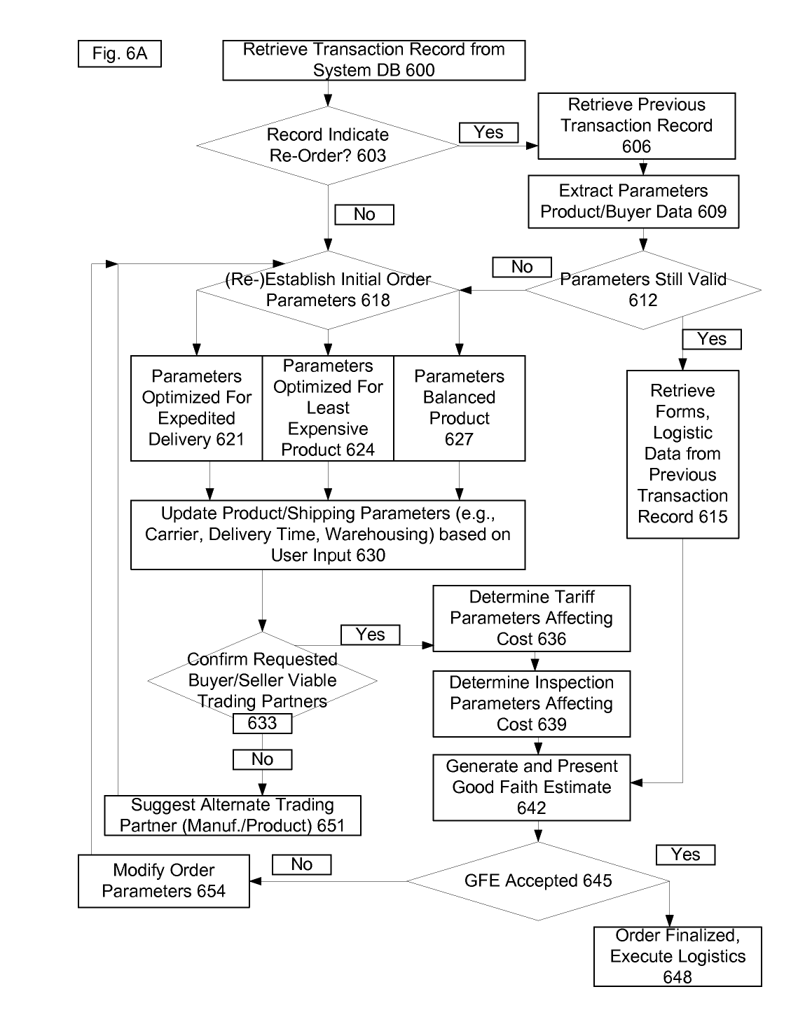

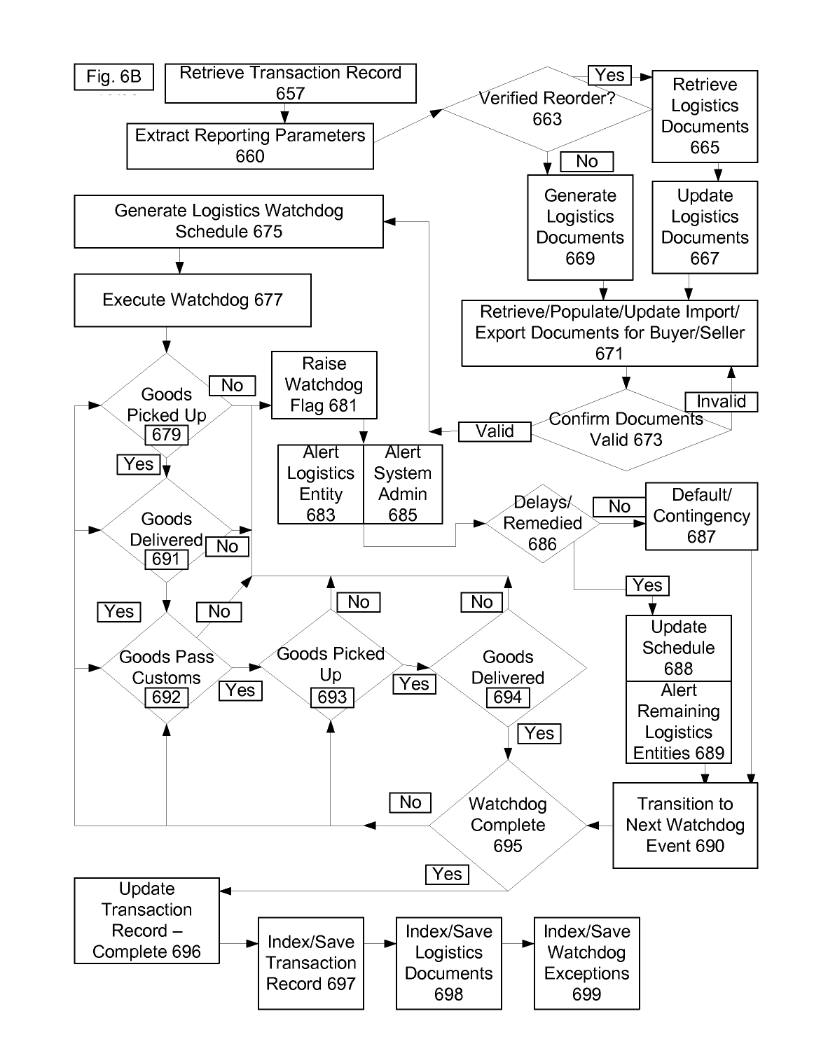

FIGS. 6A-6B illustrate aspects of system logistics components—logistics determination and logistics effication, respectively. In an implementation, the system may be configured with functionality that makes the acquisition process more efficient for repeat system users. The system logistics determination components involve processes associated with receiving the transaction record from the system database 600 (or in some instances from the system procurement components). In the event that the buyer indicates that they are accessing the system to effectuate a re-order 603, the system accesses the buyer's database records to retrieve previous logistics data 606. This data may include transaction specific data, such as product ID, SKU, manufacturer contact data, quantity data, packaging/shipping data 609 from a previous transaction. The logistics data may also include customs documentation/data, as well as payment facilitation data associated with the previous transaction. The system verifies which of the transaction parameters need to be updated. For example, the system may give the buyer the opportunity to adjust the quantities involved in the transaction, the established shipping duration, the shipping carrier, the payment facilitation method or any other numbers of transaction parameters for the re-order 612.

In the event that the transaction record indicates the transaction is not a re-order, the logistics system components are used to establish various aspects of the logistics data parameters 618. Depending on the implementation, the logistics data parameters may include a shipping carrier, product pick-up date, product delivery date, intermediary storage facilities, system affiliated or third party independent product inspection agencies, as well as customs data, such as product tariff category and expenses associated with the actual tariff. The logistics determination system components coordinate providing a variety of pricing options for the buyer. In some implementations, a registered buyer may established certain shipping preferences during the registration process (e.g., default to display least expensive shipping solution or another type of shipping solution). Accordingly, the logistics system components determines whether the buyer is a registered with the system and has established logistics shipping preferences. If the buyer has not registered with the system, the system may transition to a buyer registration process.

As part of an implementation of the logistics (re-)establishment process, the system establishes (or re-establishes) the initial order parameters 618. If the buyer has an established transaction parameters, the system may populate the initial transaction parameters optimizing the parameters for expedited delivery 621, optimizing for the least expensive parameters 624, and/or in some implementations generating a balanced set of parameters 627. The buyer may review the initial parameters and adjust a transaction parameter set (or in some instances, individual transaction parameters) 630. In some implementations, the system verifies that the seller's country and the buyer's country are viable trading partners 633. If the trading partners are determined to not be viable, the system may conduct an additional product search based on the buyer's initially requested product and suggest alternate sellers 651. Alternately, the system may conduct the verification during the procurement (products/manufacturer/search) system search, wherein trading partners that are not viable may be excluded from the search results.

If the buyer and seller are determined to be viable trading partners, the system accesses a system customs/tariff database and retrieve a tariff quote 636 for the buyer's requested product. Depending on the type of product or based on a buyer's request, the transaction may involve certain inspection costs 639. They logistics system components update these elements of the transaction record and may transmit the record back to the procurement system components for incorporation with a product pricing matrix (illustrated in FIG. 3C) or a pricing widget (FIG. 3D). In another implementation, the system finalizes the transaction record 642 and generates a good faith estimate 643 and transmits (or displays) the good faith estimate to the buyer. The buyer is presented with a final opportunity to modify transaction parameters 654. If the good faith estimate (or a finalized quote request) is accepted 645, the order is finalized and the system accesses the system logistics effication components 648.

As part of the logistics effication, the system takes a finalized good faith estimate or a binding purchase order and places the actual order with the manufacturer, books the shipping carriers, coordinates inspections, and/or customs logistics and finalizes various aspects of the transaction. This process is described in greater detail in related application entitled “SYSTEMS, METHODS AND APPARATUSES FOR IMPORTATION AND EXPORTATION TRANSACTION LOGISTICS FACILITATION”, Armand Rousso, filed Sep. 28, 2007, Attorney Docket No. 17854-004PC.

FIG. 6B illustrates aspects of the system logistics effication components. Logistics effication is initiated by retrieving (or receiving) a transaction record 657 and extracting the logistics parameters 660. The system determines whether the transaction is a verified re-order 663. If the transaction is a re-order, the system retrieves 665 and updates the previous logistics documents 667 (if necessary). If the transaction is not a re-order, the system generates the necessary logistics documents for the transaction 669. For example, the system may retrieve the documents associated with a importing/exporting a particular product; to a particular country; from a particular country.

The system populates the logistics documents the corresponding transaction parameters from the transaction record 671. In some implementations, the system may require that the generated documents are reviewed by a system administrator or a system procurement agent 673. If the system does not receive an validity confirmation indicator that documents are valid, the system may update necessary parameters. If the system receives a validity confirmation indicator that the documents are valid, the system processes the transaction record associated with the transaction and generates a logistics watchdog milestone schedule 675. The logistics watchdog milestone schedule is a checklist listing the various steps involved with transitioning the goods from the manufacturer to the buyer. The execution of the system transaction milestone checklist involves monitoring the transaction status, generating system alerts and trouble-shooting issues that arise from a defective performance. The buyer may be provided with an option to receive a system alert as various steps of the transaction are completed or log onto the system to view a current status update for a particular transaction.

FIG. 6B also illustrates an example of the system monitoring the logistics effication. However, it is to be understood that based on the preferences or needs of a particular buyer, the system may include or omit different checklist elements. By way of example only, the system may effectuate passive or active logistics monitoring. During the milestone checklist, the estimated dates associated with each milestone are retrieved from the transaction record (the estimated dates may be established during the procurement process). That is, the system may be configured to receive an indicator from the various entities involved in the transaction estimating when certain actions will be completed (e.g., goods delivered, inspected, etc . . . ). The system may also be configured for active monitoring, in which the system actively transmits a status update request to the various entities involved a transaction.

For example, in FIG. 6B, the first milestone event involves the system monitors when then goods associated with the transaction are picked up 679. If the goods are not picked up by the initial shipping carrier by the estimated pickup date, the system raises a watchdog flag 681. The system alerts the logistics entity 683(e.g, the manufacturer and the initial shipping carrier), as well as a system administrator 685.

In the event that the delays are not remedied 686, the system transitions to a default/contingency mode 687. Instead, if the delays are remedied the system updates the estimated milestone dates 688 for the remaining milestones within the milestone checklist. The system also transmits an alert(s) to the remaining logistics entities 689 to advise that the previous action dates (e.g., pickup of the goods from a shipping carrier) have been shifted.

The system then transitions to the next checklist milestone event 690. In the example illustrated in FIG. 6B, the system cycles through other events that include the delivery of the goods 691 to an inspection facility, the customs inspection of the goods 692, and picking up the goods for long haul delivery 693, as well as delievery of the goods 694. The system's alert generation process (681-690) is associated with each of the milestone events. After the completion of each milestone event, the system may generate and transmit an event completion alert for the buyer.

After the milestone checklist has been completed 695, the system updates the transaction record to indicate that the transaction has been completed 696. The system indexes and saves the completed transaction record 697, the logistics documentation 698, as well as the any watchdog exceptions that have occurred 699. The system can be configured to utilize the saved data in order to optimize the buyer's transaction experience. For example, if the transaction is a repeat order and the buyer approves the terms of the previous transaction, the buyer may pursue a one-click re-up, where the procurement process is streamlined and the buyer can simply select a “re-up” option.

The system retrieves the logistics data, establishes and effectuates the transaction based on the saved transaction data (product, shipping, inspection, and customs data) from the previous transaction. Another example of the system utilizing the saved transaction data involves categorizing the milestone exceptions into logistics entity performance metrics (e.g., rating for various manufacturers, shipping carriers, product inspectors). The system may also incorporate a direct feedback component for a buyer to rate the various entities associated with executing a transaction.

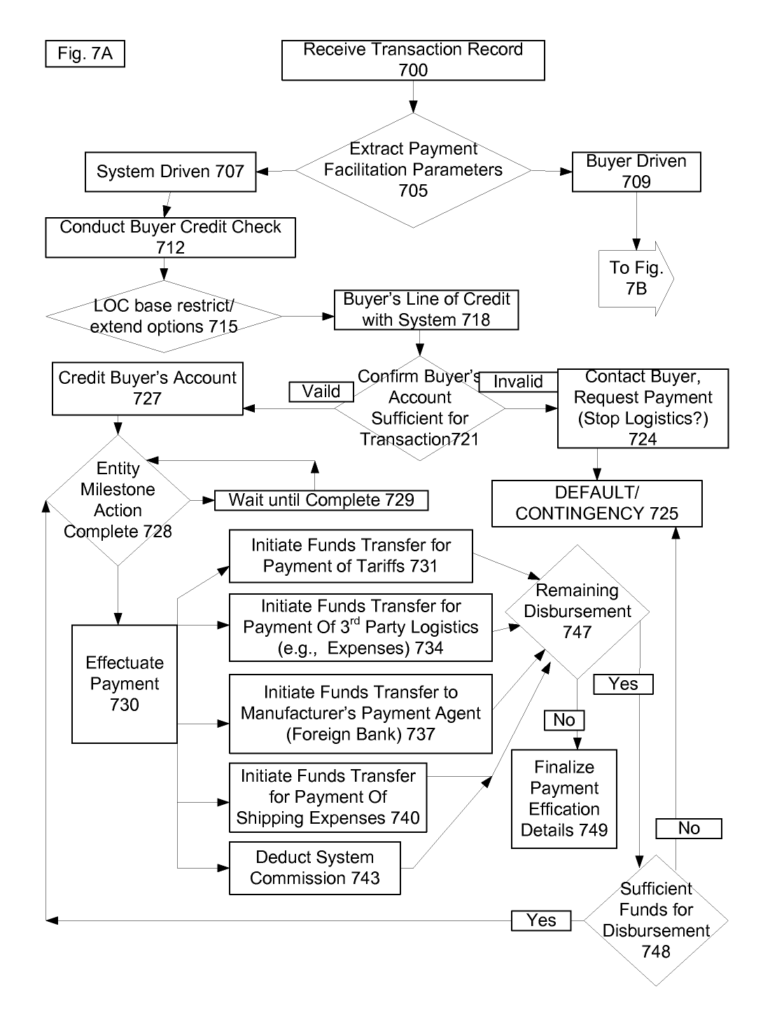

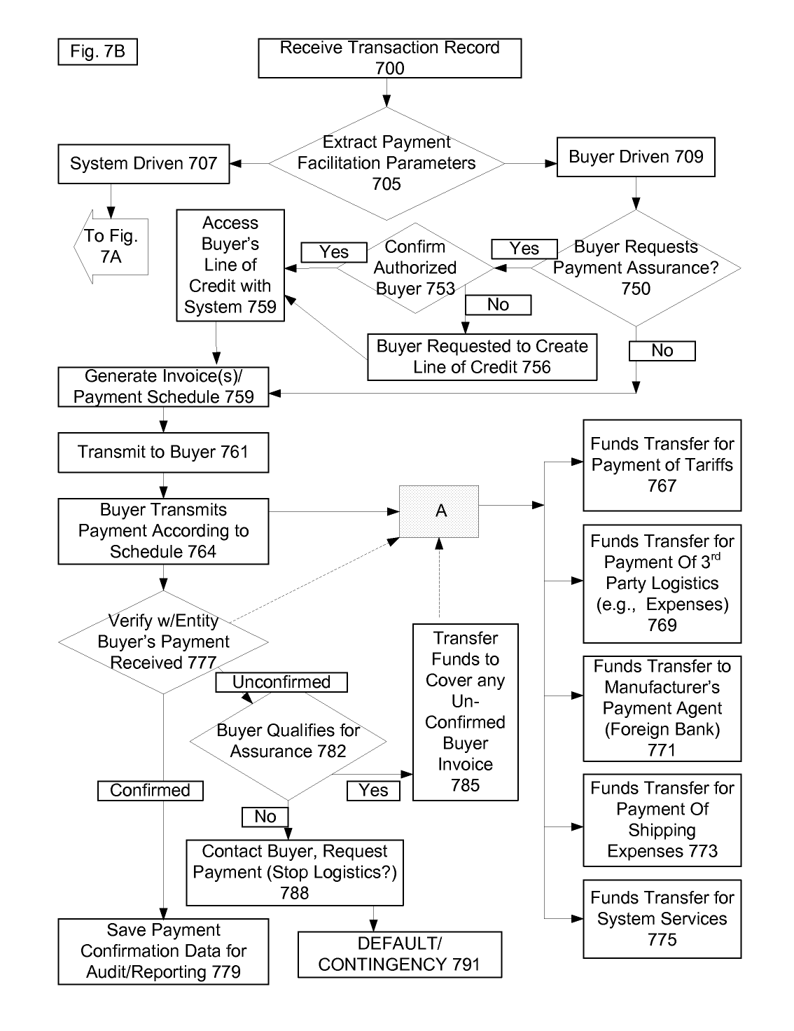

FIG. 7A illustrates aspects of the payment facilitation according to an implementation of the system. The payment facilitation system module receives the transaction record 700. The transaction record includes several payment facilitation parameters that are extracted, processed and used to coordinate aspects of payment facilitation associated with a transaction 705. For example, according to an implementation of the system, the buyer may select a system-driven 707 payment facilitation or a buyer-driven 709 payment facilitation model. System driven payment facilitation 707 involves the buyer receiving a purchase order from the system procurement component and funding an account with the system. The system is then responsible for distributing the funds to various transaction entities. The buyer selects one of the system defined available payment options presented by the system. For example, after checking a potential buyer's credit 712 and learning the buyer has a poor credit rating 715, the system may restrict the payment options for a particular buyer or require a larger deposit for a particular transaction. In contrast, if the buyer has a good credit rating, the system may offer a variety of payment options, such as creating a buyer's line of credit with the system 718.

The system verifies that the estimated transaction costs are within the buyer's available line of credit 721 (or the buyer selected payment option is a viable for the buyer, the system, and/or the manufacturer/vendor). Assuming the buyer's payment is viable, the system may be configured to update and/or credit the buyer's system account 727. In the system driven payment model, the system may determine whether an entity milestone action has been completed 728. If the action has not been completed, the system will not effectuate payment and will wait until the action is complete 729.

After the milestone action has been completed, the system effectuates payment to the entity 730. For example, the system may initiate funds transfer for payment of tariffs/customs duties 731, 3rd party logistics entities 734, the manufacturer and/or the manufacturer's payment agent 737, the cargo/shipping carriers involved in the transaction 740 and/or a system commission 743. After the funds transfer is initiated, the system determines whether there are remaining disbursements to be made 747. If the transaction is complete and there are no remaining there are remaining disbursements, the system finalizes the payment effication data and in some implementations prepares the data for a system data audit 749. If the system determines that there are additional disbursements, the system verifies that there are still sufficient funds for the remaining disbursements 748. The system transitions to a default/contingency state and generates a system contingency alert 725 if sufficient funds do not exist. The system alert may be transmitted to a buyer, a system administrator and/or in some instances remaining transaction entities 724. If there are sufficient funds for subsequent disbursements, the system transitions to verify whether the next entity milestone has been completed 728.

FIG. 7B illustrates an implementation of a buyer-driven payment facilitation system configuration. The system in the buyer-driven implementation may be configured to conduct a variety of supplemental payment verification/monitoring functionality. As illustrated, the system receives a transaction record 700 and extracts the payment facilitation parameters 705. The system may determine the payment facilitation parameters are configured to facilitate a buyer-driven payment facilitation model 709. In an implementation, the buyer requests payment “system assurance” 750. System assurance involves the system confirming that the various payments have been made and if the payment has not been made by the buyer, effectuate a payment based on a buyer's line of credit. Accordingly, if payment assurance is requested, the system verifies that the buyer is an authorized (or registered) buyer 753. The system may request that the buyer proceed through the registration process and/or establish a line of credit 756, if the buyer is not verified as authorized/registered at 753. The system accesses the verified buyer's account information and confirms the buyer's line of system credit is sufficient to proceed with the particular transaction 759. The system then transitions to generate a series of payment watchdogs flags based on the payment schedule associated with a given transaction.

Generally, the buyer is responsible for effectuating payment to the various transaction entities in the buyer-driven model. As such, the system may be configured to generate 759 and forward a series of payment invoices for each component of a given transaction to the buyer 761 (e.g., separate payment invoice(s) for the manufacturer, the short haul carrier, the long haul carrier, etc . . . ). The buyer may receive a booklet of invoices and a corresponding payment schedule. In this implementation, the buyer then transmits payment to each transaction entity according to the payment schedule 764. As illustrated in FIG. 7B, Box “A” is simply a placeholder for the various fund transfers 767,-775. As such, the buyer is ultimately responsible for transferring the funds for: the transaction tariffs 767, the payment of any involved 3rd party logistics entities 769, payment of the manufacturer 771, payment of various shipping expenses 773, payment of the system commission and/or other system expenses 775, or any other transaction fees.

The system may be configured to verify that each transaction entity has received payment from the buyer 777 to fulfill assurance 750 responsibilities and/or maintain data auditing/reporting records 779. If the system confirms the transaction entity has been paid, the system updates the transaction record with a payment confirmation indicator 779. In contrast, if the system is not able to confirm that the buyer has effectuated the payment transfer, the system may determine whether the buyer has registered for system payment assurance 782. If the buyer has registered for payment assurance and the payment transfer is due, the system may be configured to step in for the buyer and effectuate payment based on the buyer's line of system credit 785. If the buyer has not registered for system assurance, the system may generate and transmit a system alert to the buyer indicating that the payment is due (or past due) 788. In some instances the system may transition to a default/contingency state, where subsequent transaction entities are alerted to a possible default condition 791. For example, if the manufacturer's payment has not been effectuated and the buyer has not registered for system assurance, the system may generate and transmit a system alert to the long haul carrier indicating that there may be transaction delays and/or default.

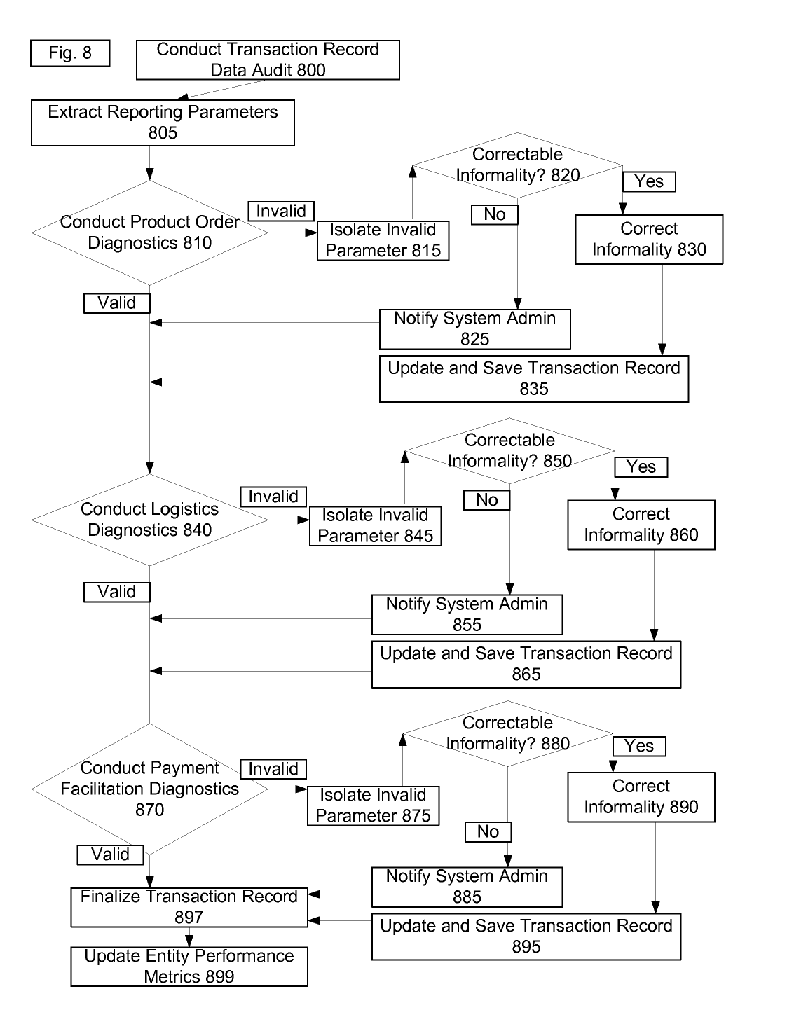

FIG. 8 illustrates aspects of functionality associated with managing system transaction data, data auditing and data reporting components. In an implementation, the system may be configured to conduct data auditing and/or process transaction data records to populate a transaction library and/or transaction recorddatabase. The system transaction database may be used for a variety of transaction functionality, such as creating templates for transactions or building transaction service provider catalogs for use by the system procurement/logistics components.

In an example, the data may be used to provide buyer with the ability to submit a re-order based on the buyer's previous transaction record. This type of one-click re-up may be used to enable an efficient re-order for large-scale transactions that are inherently difficult to coordinate by re-using the previous logistics data and minimizing the additional data required from the buyer. In another example, a buyer may be provided with a opportunity to re-use the data from the one or more of his previous transactions, but make a minor change (e.g., order 15,000 widgets, instead of the previously ordered 20,000 widgets) as a two-click re-up. This is made possible by the flexible nature of the system, in that the system may re-adjust the logistics data as necessary to ship the goods with minimal input from the buyer.

In another implementation, the system may process transaction records to extract data for system usage. For example, the processed data may also be used to build service provider catalogs for a variety of service providers across a variety of industries, goods and/or geographic locations or countries, such as a listing of a rail carriers that provide service for transporting goods from the port of New Orleans to areas in the Mid-West United States. As another example, the system may provide buyer(s) or seller(s) with the ability to rate the performance of one or more of the transaction entities involved in a particular transaction.

Over time, this data may be aggregated to create a significant resource that may be used as a another search metric to supplement the procurement processes (e.g., a buyer can conduct a search for wine glasses produced by 4-starr manufacturers). As yet another example, transaction data may also be utilized to build system derived transaction entity confidence metrics related to buyers, sellers, or other transaction entities (e.g., long/short haul carriers, 3rd party logistics entities, vendors, retailers or any other entity involved in transactions). In an example, the system may provide performance metrics that gives the buyer the opportunity to select between a particular long haul carrier that has a 97% on-time delivery performance rating or a 67% on-time delivery performance rating.

In order to determine these types of metrics, the system may be configured to conduct data auditing functionality at various points during a transaction. For example, the system may analyze how well particular entities perform, when compared to the transaction milestone schedule. FIG. 8 illustrates an implementation of system data auditing 800. The system extracts a series of data reporting parameters that may vary depending on the implementation 805. Examples of data reporting parameters that may be incorporated with a transaction record include parameters that help measure performance during procurement 810, logistics determination 840, logistics effication 840, and payment facilitation 870. In this implementation, the system may process the transaction record and determine whether one or more exception flags has been generated. As several examples, an exception flag may be generated when:
the system procurement engine generates an order that accepted by the buyer for a good that the manufacturer is unable to provide;
a provided good that does not meet the buyer's requested specification;
a goods shipper/carrier does not deliver the goods in line with the estimated time for delivery (in some instances the system may also record early and/or late deliveries, as well as the divergence from the provided milestone estimated time for delivery from the buyer's transaction record); or
a buyer who has been verified uses system assurance, but does not have the resources to repay the payment effectuated on behalf of the buyer; or
any other number of instances during a transaction when things do not go as planned.

Accordingly, once the auditing parameters are extracted 805, the system conducts product order diagnostics 810 to determine whether exception flags have been generated. If the system identifies an exception flag, the invalid parameter is isolated and identified 815. In some implementations, data auditing may be conducted dynamically throughout the transaction or after each stage of the transaction is complete. If the exception relates to a correctable informality, such as the manufacturer providing an inconsistent product shipping term, the system may be configured to identify correctable informalities 820 and determines the appropriate steps to correct the informality 830 and update/save the transaction record or notifies a system administrator 825 who may be able to assist with saving a transaction from a contingency/default state. Similar processing may be run for logistics diagnostics data 840, as well as payment facilitation data 870. Regardless of whether the data is updated dynamically or when the transaction has been completed, the finalized transaction record 897 data may be used to the update stored entity performance metrics and/or buyer/seller entity ratings 899.

Facilitator Controller

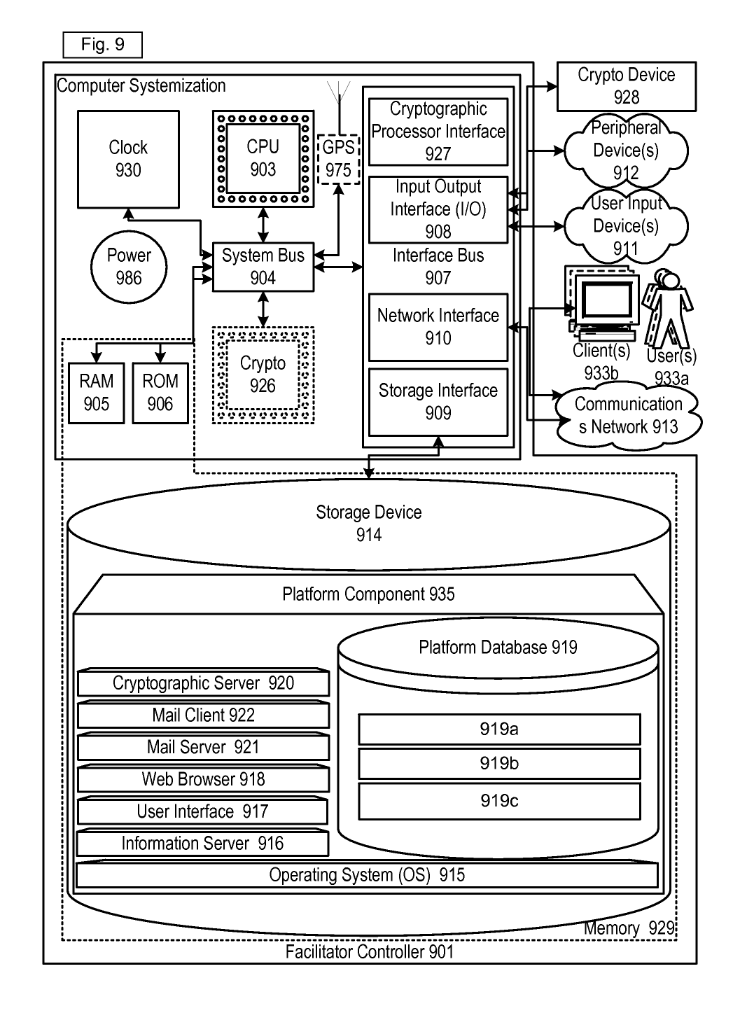

FIG. 9 of the present disclosure illustrates inventive aspects of a Facilitator controller 901 in a block diagram. In this embodiment, the Facilitator controller 901 may serve to aggregate, process, store, search, serve, identify, instruct, generate, match, and/or facilitate interactions with a computer through a variety of technologies, and/or other related data.

Typically, users, which may be people and/or other systems, engage information technology systems (e.g., commonly computers) to facilitate information processing. In turn, computers employ processors to process information; such processors are often referred to as central processing units (CPU). A common form of processor is referred to as a microprocessor. CPUs use communicative signals to enable various operations. Such communicative signals may be stored and/or transmitted in batches as program and/or data components facilitate desired operations. These stored instruction code signals may engage the CPU circuit components to perform desired operations. A common type of program is a computer operating system, which, commonly, is executed by CPU on a computer; the operating system enables and facilitates users to access and operate computer information technology and resources. Common resources employed in information technology systems include: input and output mechanisms through which data may pass into and out of a computer; memory storage into which data may be saved; and processors by which information may be processed. Often information technology systems are used to collect data for later retrieval, analysis, and manipulation, commonly, which is facilitated through a database program. Information technology systems provide interfaces that allow users to access and operate various system components.

In one embodiment, the Facilitator controller 901 may be connected to and/or communicate with entities such as, but not limited to: one or more users from user input devices 911; peripheral devices 912; a cryptographic processor device 928; and/or a communications network 913.

Networks are commonly thought to comprise the interconnection and interoperation of clients, servers, and intermediary nodes in a graph topology. It should be noted that the term “server” as used throughout this disclosure refers generally to a computer, other device, program, or combination thereof that processes and responds to the requests of remote users across a communications network. Servers serve their information to requesting “clients.” The term “client” as used herein refers generally to a computer, other device, program, or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The Facilitator controller 901 may be based on common computer systems that may comprise, but are not limited to, components such as: a computer systemization 902 connected to memory 929.

Computer Systemization

A computer systemization 902 may comprise a clock 930, central processing unit (CPU) 903, a read only memory (ROM) 906, a random access memory (RAM) 905, and/or an interface bus 907, and most frequently, although not necessarily, are all interconnected and/or communicating through a system bus 904. Optionally, the computer systemization may be connected to an internal power source 986. Optionally, a cryptographic processor 926 may be connected to the system bus. The system clock typically has a crystal oscillator and provides a base signal. The clock is typically coupled to the system bus and various clock multipliers that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s). The CPU interacts with memory through signal passing through conductive conduits to execute stored signal program code according to conventional data processing techniques. Such signal passing facilitates communication within the Facilitator controller and beyond through various interfaces. Should processing requirements dictate a greater amount speed, parallel, mainframe and/or super-computer architectures may similarly be employed.Alternatively, should deployment requirements dictate greater portability, smaller Personal Digital Assistants (PDAs) may be employed.

Power Source

The power source 986 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 986 is connected to at least one of the interconnected subsequent components of the Facilitator thereby providing an electric current to all subsequent components. In one example, the power source 986 is connected to the system bus component 904. In an alternative embodiment, an outside power source 986 is provided through a connection across the I/O 908 interface. For example, a USB and/or IEEE 1394 connection carries both data and power across the connection and is therefore a suitable source of power.

Interface Adapters

Interface bus(ses) 907 may accept, connect, and/or communicate to a number of interface adapters, conventionally although not necessarily in the form of adapter cards, such as but not limited to: input output interfaces (I/O) 908, storage interfaces 909, network interfaces 910, and/or the like. Optionally, cryptographic processor interfaces 927 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 909 may accept, communicate, and/or connect to a number of storage devices such as, but not limited to: storage devices 914, removable disc devices, and/or the like. Storage interfaces may employ connection protocols such as, but not limited to: (Ultra) (Ser.) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 910 may accept, communicate, and/or connect to a communications network 913. Through a communications network 150, the Facilitator controller is accessible through remote clients 933b (e.g., computers with web browsers) by users 933a. Network interfaces may employ connection protocols such as, but not limited to: direct connect, Ethernet (thick, thin, twisted pair 10/100/1000 Base T, and/or the like), Token Ring, wireless connection such as IEEE 802.11 a-x, and/or the like. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 910 may be used to engage with various communications network types 913. For example, multiple network interfaces may be employed to allow for the communication over broadcast, multicast, and/or unicast networks.

Input Output interfaces (I/O) 908 may accept, communicate, and/or connect to user input devices 911, peripheral devices 912, cryptographic processor devices 928, and/or the like. I/O may employ connection protocols such as, but not limited to: Apple Desktop Bus (ADB); Apple Desktop Connector (ADC); audio: analog, digital, monaural, RCA, stereo, and/or the like; IEEE 1394a-b; infrared; joystick; keyboard; midi; optical; PC AT; PS/2; parallel; radio; serial; USB; video interface: BNC, coaxial, composite, digital, Digital Visual Interface (DVI), RCA, RF antennae, S-Video, VGA, and/or the like; wireless; and/or the like. A common output device is a television set, which accepts signals from a video interface. Also, a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable, etc.).

User input devices 911 may be card readers, dongles, finger print readers, gloves, graphics tablets, joysticks, keyboards, mouse (mice), remote controls, retina readers, trackballs, trackpads, and/or the like.

Peripheral devices 912 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the Facilitator controller may be embodied as an embedded, dedicated, and/or monitor-less (i.e., headless) device, wherein access would be provided over a network interface connection.

Cryptographic units such as, but not limited to, microcontrollers, processors 926, interfaces 927, and/or devices 928 may be attached, and/or communicate with the Facilitator controller. A MC68HC16 microcontroller, commonly manufactured by Motorola Inc., may be used for and/or within cryptographic units. Equivalent microcontrollers and/or processors may also be used. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Other commercially available specialized cryptographic processors include VLSI Technology's 33 MHz 6868 or Semaphore Communications' 40 MHz Roadrunner.

Memory

Generally, any mechanization and/or embodiment allowing a processor to affect the storage and/or retrieval of information is regarded as memory 929. However, memory is a fungible technology and resource, thus, any number of memory embodiments may be employed in lieu of or in concert with one another. It is to be understood that the Facilitator controller and/or a computer systemization may employ various forms of memory 929. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 929 will include ROM 906, RAM 905, and a storage device 914. A storage device 914 may be any conventional computer system storage. Storage devices may include a drum; a (fixed and/or removable) magnetic disk drive; a magneto-optical drive; an optical drive (i.e., CD ROM/RAM/Recordable (R), ReWritable (RW), DVD R/RW, etc.); an array of devices (e.g., Redundant Array of Independent Disks (RAID)); and/or other devices of the like. Thus, a computer systemization generally requires and makes use of memory.

Component Collection

The memory 929 may contain a collection of program and/or database components and/or data such as, but not limited to: operating system component(s) 915 (operating system); information server component(s) 916 (information server); user interface component(s) 917 (user interface); Web browser component(s) 918 (Web browser); database(s) 919; mail server component(s) 921; mail client component(s) 922; cryptographic server component(s) 920 (cryptographic server); the Facilitator component(s) 935; and/or the like (i.e., collectively a component collection). These components may be stored and accessed from the storage devices and/or from storage devices accessible through an interface bus. Although non-conventional program components such as those in the component collection, typically, are stored in a local storage device 914, they may also be loaded and/or stored in memory such as: peripheral devices, RAM, remote storage facilities through a communications network, ROM, various forms of memory, and/or the like.

Operating System

The operating system component 915 is an executable program component facilitating the operation of the FACILITATOR controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the Facilitator controller to communicate with other entities through a communications network 913. Various communication protocols may be used by the Facilitator controller as a subcarrier transport mechanism for interaction, such as, but not limited to: multicast, TCP/IP, UDP, unicast, and/or the like.

Information Server

An information server component 916 is a stored program component that is executed by a CPU. The information server may be a conventional Internet information server such as, but not limited to Apache Software Foundation's Apache, Microsoft's Internet Information Server, and/or the. The information server may allow for the execution of program components through facilities such as Active Server Page (ASP), ActiveX, (ANSI) (Objective-) C (++), C# and/or .NET, Common Gateway Interface (CGI) scripts, Java, JavaScript, Practical Extraction Report Language (PERL), Hypertext Pre-Processor (PHP), pipes, Python, WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the Facilitator controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the Facilitator database 919, operating systems, other program components, user interfaces, Web browsers, and/or the like.

Access to the Facilitator database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the Facilitator. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the Facilitator as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/Vista (i.e., Aero)/XP, or Unix's X-Windows (e.g., which may include additional Unix graphic interface libraries and layers such as K Desktop Environment (KDE), mythTV and GNU Network Object Model Environment (GNOME)), provide a baseline and means of accessing and displaying information graphically to users.

A user interface component 917 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component 918 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Some Web browsers allow for the execution of program components through facilities such as Java, JavaScript, ActiveX, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the Facilitator enabled nodes. The combined application may be nugatory on systems employing standard Web browsers.

Mail Server

A mail server component 921 is a stored program component that is executed by a CPU 903. The mail server may be a conventional Internet mail server such as, but not limited to sendmail, Microsoft Exchange, and/or the. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the Facilitator.

Access to the Facilitator mail may be achieved through a number of APIs offered by the individual Web server components and/or the operating system.

Also, a mail server may contain, communicate, generate, obtain, and/or provide program component, system, user, and/or data communications, requests, information, and/or responses.

Mail Client

A mail client component 922 is a stored program component that is executed by a CPU 903. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

Cryptographic Server

A cryptographic server component 920 is a stored program component that is executed by a CPU 903, cryptographic processor 926, cryptographic processor interface 927, cryptographic processor device 928, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the Facilitator may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the Facilitator component to engage in secure transactions if so desired. The cryptographic component facilitates the secure accessing of resources on the Facilitator and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

The Facilitator Database

The Facilitator database component 919 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the Facilitator database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like.

Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the Facilitator database is implemented as a data-structure, the use of the Facilitator database 919 may be integrated into another component such as the Facilitator component 935. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 919 includes several tables 919a-c. A registered buyer data table 919a includes fields such as, but not limited to: buyer credit data, buyer transaction records, and/or the like. The buyer table may support and/or track multiple entity accounts on a Facilitator. A system product table 919b includes fields such as, but not limited to: product description data, product pricing, and/or the like. A system affiliated manufacturer table 919c includes fields such as, but not limited to: product description data associated with a manufacturer, manufacturer affiliated shipping data, and/or the like.

In one embodiment, user programs may contain various user interface primitives, which may serve to update the Facilitator. Also, various accounts may require custom database tables depending upon the environments and the types of clients the Facilitator may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 919a-c. The Facilitator may be configured to keep track of various settings, inputs, and parameters via database controllers.

The Facilitator database may communicate to and/or with other components in a component collection, including itself, and/or facilities of the like. Most frequently, the Facilitator database communicates with the Facilitator components (e.g., Facilitator system procurement components, logistics components and/or payment facilitation components, other program components, and/or the like. The database may contain, retain, and provide information regarding other nodes and data.

The Facilitators

The Facilitator component 935 is a stored program component that is executed by a CPU. In one embodiment, the Facilitator component incorporates any and/or all combinations of the aspects of the Facilitator that was discussed in the previous figures. As such, the Facilitator affects accessing, obtaining and the provision of information, services, transactions, and/or the like across various communications networks.

The Facilitator component enables the logistics, procurement, payment facilitation components and/or the like and use of the transaction facilitation system.

The Facilitator component enabling access of information between nodes may be developed by employing standard development tools and languages such as, but not limited to: Apache components, Assembly, ActiveX, binary executables, (ANSI) (Objective) C (++), C# and/or .NET, database adapters, CGI scripts, Java, JavaScript, mapping tools, procedural and object oriented development tools, PERL, PHP, Python, shell scripts, SQL commands, web application server extensions, WebObjects, and/or the like. In one embodiment, the Facilitator server employs a cryptographic server to encrypt and decrypt communications. The Facilitator component may communicate to and/or with other components in a component collection, including itself, and/or facilities of the like. Most frequently, the Facilitator component communicates with the Facilitator database, operating systems, other program components, and/or the like. The Facilitator may contain, communicate, generate, obtain, and/or provide program component, system, user, and/or data communications, requests, and/or responses.

Distributed Facilitators

The structure and/or operation of any of the Facilitator node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the Facilitator controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), local and remote application program interfaces Jini, Remote Method Invocation (RMI), process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. Again, the configuration will depend upon the context of system deployment.

The entirety of this disclosure (including the Cover Page, Title, Headings, Field, Background, Summary, Brief Description of the Drawings, Detailed Description, Claims, Abstract, Figures, and otherwise) shows by way of illustration various embodiments in which the claimed inventions may be practiced. The advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims.

What is claimed is:

1. A method for facilitating procurement associated with a cross-border transaction comprising:
receiving a search request from a system user, wherein the search request includes product and shipping related data;
generating a quote for the transaction and transmitting the quote to the user;
receiving an indication that the transaction quote has been finalized by the user;
effectuating one or more transaction logistics elements based on the product and shipping details included in the finalized quote; and
facilitating payment of one or more entities involved in the transaction.

2. The method of claim 1, further comprising:
processing the transaction record as part of a transaction data audit.

3. The method of claim 2, wherein the data audit is conducted dynamically as the transaction is pending.

4. The method of claim 3, wherein the data audit is conducted after the transaction has been completed.

5. The method of claim 4, wherein the payment facilitation is based on a system-driven payment facilitation model.

6. The method of claim 5, wherein the payment facilitation is based on a buyer-driven payment facilitation model.

7. The method of claim 6, wherein the buyer is provided with an option for requesting system assurance.

8. A method for facilitating logistics associated with a cross-border transaction comprising:
retrieving a transaction record that includes product procurement and payment facilitation data for a product and a buyer associated with a transaction;
determining one or more logistics solutions based on the procurement data;
generating a product order for the transaction based on a selected logistics solution, product data and payment facilitation data for the transaction;
effectuating the logistics involved in transferring the products associated with a transaction from the seller to the buyer based an a finalized product order; and
confirming one or more transaction events have been effectuated and generating an exception alert if a transaction event is confirmed has not completed in accordance with the transaction parameters included in the finalized product order.

9. A method for facilitating payment associated with a cross-border transaction:
retrieving procurement data associated with a transaction record;
retrieving logistics data associated with a transaction record;
determining available payment options based on procurement data, and logistics data associated with a product identifier and registered buyer characteristic data;
presenting the available payment options to the buyer; and
receiving a buyer payment option selection, wherein if the buyer selects a system driven payment option the system effectuates payment to one or more transaction entities or if the buyer selects a buyer driven payment option the system confirms each transaction entity has been paid by the buyer in accordance with a finalized sales order.

10. A method of providing searchable access to an available product catalog comprising:
receiving one or more product detail objects from a manufacturer that includes product details;
populating the available product catalog with the product detail objects;
receiving a product search request that includes procurement search requested data and requested logistics data;
displaying one or more products that are correlated to elements of the product search request;
receiving a buyer product selection; and
generating and displaying an interactive product transaction interface that includes product description detail, an initial logistics solution for a transaction, and a listing of available payment option.

11. The method of claim 10, further comprising:
processing the transaction record as part of a transaction data audit.

12. The method of claim 11, wherein the data audit is conducted dynamically as the transaction is pending.

13. The method of claim 12, wherein the data audit is conducted after the transaction has been completed.

14. The method of claim 13, wherein the payment facilitation is based on a system-driven payment facilitation model.

15. The method of claim 14, wherein the payment facilitation is based on a buyer-driven payment facilitation model.

16. The method of claim 15, wherein the buyer is provided with an option for requesting system assurance.

17. An apparatus for facilitating procurement associated with a cross-border transaction comprising:
a processor;
a memory in communication with the processor and containing program instructions;
an input and output in communication with the processor and memory;
wherein the processor executes program instructions contained in the memory and the program instructions comprise:
receiving a search request from a system user, wherein the search request includes product and shipping related data;
generating a quote for the transaction and transmitting the quote to the user;
receiving an indication that the transaction quote has been finalized by the user;
effectuating one or more transaction logistics elements based on the product and shipping details included in the finalized quote; and
facilitating payment of one or more entities involved in the transaction.

18. The apparatus of claim 17, wherein the program instruction further comprise:
processing the transaction record as part of a transaction data audit.

19. The apparatus of claim 18, wherein the data audit is conducted dynamically as the transaction is pending.

20. The apparatus of claim 19, wherein the data audit is conducted after the transaction has been completed.

21. The apparatus of claim 20, wherein the payment facilitation is based on a system-driven payment facilitation model.

22. The apparatus of claim 21, wherein the payment facilitation is based on a buyer-driven payment facilitation model.

23. The apparatus of claim 22, wherein the buyer is provided with an option for requesting system assurance.
